(19) United States
(12) Patent Application Publication
(10) Pub. No.: US 2025/0192422 A1
(43) Pub. Date: Jun. 12, 2025

(54) Antenna Assembly, Signal Transmitting Apparatus, and Vehicle

(71) Applicant: Shenzhen Yinwang Intelligent Technologies Co., Ltd., Shenzhen (CN)

(72) Inventors: Tongjie Li, Dongguan (CN); Zhiguo Huang, Dongguan (CN); Bei Fu, Dongguan (CN)

(21) Appl. No.: 19/057,285

(22) Filed: Feb. 19, 2025

Related U.S. Application Data
(63) Continuation of application No. PCT/CN2022/113768, filed on Aug. 19, 2022.

(51) Int. Cl. H01Q 1/32; H01Q 15/00

(52) U.S. Cl. CPC H01Q 1/3275; H01Q 15/00

(57) ABSTRACT

An antenna assembly includes a first antenna element disposed on a surface that is of a second dielectric layer that is distal from a first dielectric layer. A second antenna element is disposed between an intermediate dielectric layer and the first dielectric layer, and a third antenna element is disposed between the intermediate dielectric layer and the second dielectric layer.

### CROSS-REFERENCE TO RELATED APPLICATIONS

This is a continuation of International Patent Application No. PCT/CN2022/113768, filed on Aug. 19, 2022, the disclosure of which is hereby incorporated by reference in its entirety.

### TECHNICAL FIELD

Embodiments of this disclosure relate to the field of communication device technologies, and specifically, to an antenna assembly, a signal transmitting apparatus, and a vehicle.

### BACKGROUND

With gradual development of automobile manufacturing technologies, a shark fin structure is disposed on a top of an automobile, the shark fin is located outside the top of the automobile, an antenna assembly is disposed in the shark fin structure, and communication with an external device can be implemented through the antenna assembly. However, signal strength of the antenna assembly is weak, and communication quality may be affected.

### SUMMARY

Embodiments of this disclosure provide an antenna assembly, a signal transmitting apparatus, and a vehicle, to resolve a problem that signal strength of the antenna assembly is weak.

According to one aspect, embodiments provide an antenna assembly, including a first dielectric layer, a second dielectric layer, and an intermediate dielectric layer, where the second dielectric layer and the first dielectric layer are laminated, and the intermediate dielectric layer is located between the first dielectric layer and the second dielectric layer.

The antenna assembly further includes a first antenna element, a second antenna element, and a third antenna element, where the first antenna element is disposed on a surface that is of the second dielectric layer and that is away from the first dielectric layer; the second antenna element is disposed between the intermediate dielectric layer and the first dielectric layer; and the third antenna element is disposed between the intermediate dielectric layer and the second dielectric layer.

According to the antenna assembly provided in this embodiment, the first antenna element, the second antenna element, and the third antenna element all transmit a signal to the outside, so that signal transmitting strength of the antenna assembly can be improved, to improve communication quality of the antenna assembly.

In some embodiments that may include the foregoing embodiments, the antenna assembly further includes a reflection element, the reflection element is located on a side that is of the second dielectric layer and that is away from the first dielectric layer, and the reflection element is configured to reflect a signal transmitted by the first antenna element, the second antenna element, and the third antenna element to the reflection element.

In this disposition, after being reflected on the reflection element, a signal may be transmitted in a direction that is of the first dielectric layer and that is away from the reflection element, so that a radiation pattern of the antenna assembly is hemispherical. Compared with a spherical radiation pattern of the antenna assembly, the signal transmitted to the reflection element may be reflected to a side that is of the first dielectric layer and that is away from the reflection element, to improve signal strength of the side that is of the first dielectric layer and that is away from the reflection element, so as to improve communication quality. In addition, a signal loss can be reduced, and efficiency of the antenna assembly is improved.

In some embodiments that may include the foregoing embodiments, in projections on the intermediate dielectric layer, a projection of the reflection element covers all projections of the first antenna element, the second antenna element, and the third antenna element. In this disposition, all signals that are generated by the first antenna element, the second antenna element, and the third antenna element and that are transmitted to the reflection element may be reflected on the reflection element, to avoid a signal loss caused when a part of the signals is not reflected by the reflection element.

In some embodiments that may include the foregoing embodiments, in projections on the intermediate dielectric layer, a projection of the reflection element covers a projection of a part of the first antenna element, a projection of a part of the second antenna element, and a projection of a part of the third antenna element. In this disposition, the reflection element may reflect a specific signal (for example, a signal with a specific frequency) generated by the first antenna element, the second antenna element, and the third antenna element, to enhance signal strength of the specific signal.

In some embodiments that may include the foregoing embodiments, there is a first distance between the reflection element and the first antenna element. The first distance is properly set, to improve a reflection effect of the reflection element on a signal.

In some embodiments that may include the foregoing embodiments, the first distance is 0.05 to 1 times a wavelength of the signal transmitted by the first antenna element, the second antenna element, and the third antenna element. For example, the first distance may be 0.1 to 0.5 times the wavelength of the signal transmitted by the first antenna element, the second antenna element, and the third antenna element. For example, the first distance may be 0.1, 0.3, 0.5, or the like times the wavelength of the signal transmitted by the first antenna element, the second antenna element, and the third antenna element. In this disposition, a reflection effect of the reflection element on the signal transmitted by the first antenna element, the second antenna element, and the third antenna element can be improved.

In some embodiments that may include the foregoing embodiments, a dielectric layer is disposed between the first antenna element and the reflection element.

In some embodiments that may include the foregoing embodiments, the reflection element includes a reflection plate. Signal reflection is performed on the reflection plate. In this way, a structure is simple, and manufacturing is easy.

In some embodiments that may include the foregoing embodiments, a guide structure is disposed on the reflection element, and the guide structure is configured to reflect a signal towards a first direction. This disposition can improve signal strength in the first direction, and further improve communication quality.

In some embodiments that may include the foregoing embodiments, the guide structure includes a guide protrusion and/or a guide groove provided on the reflection element. In this disposition, the guide protrusion and/or the guide groove are/is provided on the reflection element, so that a signal is transmitted towards the first direction after being reflected. In this way, a structure is simple, and manufacturing is easy.

In some embodiments that may include the foregoing embodiments, the guide structure includes a first guide structure and a second guide structure, and the first guide structure and the second guide structure are disposed on the reflection element at a spacing. In this disposition, more signals can be reflected towards the first direction, to further improve signal strength in the first direction.

In some embodiments that may include the foregoing embodiments, the guide structure and the reflection element are an integrated structure.

In some embodiments that may include the foregoing embodiments, the guide structure is connected to the reflection element.

In some embodiments that may include the foregoing embodiments, a through hole is provided on the reflection element. In this disposition, the reflection element forms a slot antenna, and the first antenna element may couple a signal to the slot antenna, so that the slot antenna, the first antenna element, the second antenna element, and the third antenna element all can transmit a signal to the outside, to improve signal strength, and further improve communication quality.

In some embodiments that may include the foregoing embodiments, the antenna assembly further includes a feed line, and the feed line is electrically connected to the first antenna element.

In some embodiments that may include the foregoing embodiments, the first antenna element is configured to couple a signal to the second antenna element and the third antenna element. The first antenna element feeds the second antenna element and the second antenna element in a wireless manner. This disposition can reduce a quantity of wires of the antenna assembly and complexity of routing layout, and can further reduce a weight of the antenna assembly, to implement lightweight of the antenna assembly.

According to one aspect, embodiments of this disclosure further provide an antenna assembly, including an antenna element and a reflection element, where the reflection element and the antenna element are disposed at a spacing, and the reflection element is configured to reflect a signal transmitted by the antenna element to the reflection element.

In this disposition, a signal radiation pattern generated by the antenna element is concentrated on a side that is of the antenna element and that is away from the reflection element, and the radiation pattern is hemispherical, so that signal strength on the side that is of the antenna element and that is away from the reflection element is improved, to improve communication quality. In addition, a signal loss caused by signal transmission to a location of a non-communication region like the ground can be avoided, to improve efficiency of the antenna assembly.

In some embodiments that may include the foregoing embodiments, a projection of the reflection element covers a part of the antenna element in a plane in which the antenna element is located. In this disposition, a part of the signal transmitted by the antenna element is reflected on the reflection element, so that a specific signal (for example, a signal of a specific frequency) is reflected on the reflection element, to enhance signal strength of the specific signal.

In some embodiments that may include the foregoing embodiments, a projection of the reflection element covers all the antenna element in a plane in which the antenna element is located. In this disposition, all signals that are generated by the antenna element and that are transmitted to the reflection element are reflected on the reflection element, to avoid a signal loss caused when a part of the signals is not reflected by the reflection element.

In some embodiments that may include the foregoing embodiments, there is a first distance between the reflection element and the antenna element. The first distance is properly set, to improve a reflection effect of the reflection element on a signal.

In some embodiments that may include the foregoing embodiments, the first distance is 0.05 to 1 times a wavelength of the signal transmitted by the antenna element. For example, the first distance may be 0.1 to 0.5 times the wavelength of the signal transmitted by the antenna assembly. For example, the first distance may be 0.1, 0.3, 0.5, or the like times the wavelength of the signal transmitted by the antenna assembly. In this disposition, a reflection effect of the reflection element on the signal transmitted by the antenna element can be improved.

In some embodiments that may include the foregoing embodiments, a dielectric layer is disposed between the antenna element and the reflection element.

In some embodiments that may include the foregoing embodiments, the reflection element includes a reflection plate, and the reflection plate and the antenna element are disposed at a spacing. Signal reflection is performed on the reflection plate. In this way, a structure is simple, and manufacturing is easy.

In some embodiments that may include the foregoing embodiments, a guide structure is disposed on the reflection element, and the guide structure is configured to reflect a signal towards a first direction. This disposition can improve signal strength in the first direction, and further improve communication quality.

In some embodiments that may include the foregoing embodiments, the guide structure includes a guide protrusion and/or a guide groove provided on the reflection element. In this disposition, the guide protrusion and/or the guide groove are/is provided on the reflection element, so that a signal is transmitted towards the first direction after being reflected on the guide structure. In this way, a structure is simple, and manufacturing is easy.

In some embodiments that may include the foregoing embodiments, the guide structure includes a first guide structure and a second guide structure, and the first guide structure and the second guide structure are disposed on the reflection element at a spacing. In this disposition, more signals can be reflected towards the first direction, to further improve signal strength in the first direction.

In some embodiments that may include the foregoing embodiments, the guide structure and the reflection element are an integrated structure.

In some embodiments that may include the foregoing embodiments, the guide structure is connected to the reflection element.

In some embodiments that may include the foregoing embodiments, a through hole is provided on the reflection element. In this disposition, the reflection element forms a slot antenna, and in this case, the first antenna element may couple a signal to the slot antenna, so that the slot antenna, the first antenna element, the second antenna element, and the third antenna element all can transmit a signal to the outside, to improve signal strength, and further improve communication quality.

In some embodiments that may include the foregoing embodiments, the antenna assembly includes a first dielectric layer, the antenna element includes a first antenna element, the first antenna element is disposed on the first dielectric layer, and the reflection element and the first dielectric layer are disposed at a spacing.

In some embodiments that may include the foregoing embodiments, the antenna assembly further includes a second dielectric layer, where the second dielectric layer and the first dielectric layer are laminated, and the second dielectric layer is disposed to face the reflection element, and an intermediate dielectric layer, where the intermediate dielectric layer is located between the first dielectric layer and the second dielectric layer, and the first antenna element is disposed on a surface that is of the second dielectric layer and that is away from the first dielectric layer. This disposition can prevent an external object from being in contact with the first antenna element, to protect the first antenna element.

In some embodiments that may include the foregoing embodiments, the antenna element further includes a second antenna element, and the second antenna element is disposed between the intermediate dielectric layer and the first dielectric layer. In this disposition, the second antenna element and the first antenna element may simultaneously receive and transmit signals, to improve strength of a signal transmitted by the antenna assembly, and improve communication quality.

In some embodiments that may include the foregoing embodiments, the antenna element further includes a third antenna element, and the third antenna element is disposed between the intermediate dielectric layer and the second dielectric layer. In this disposition, the third antenna element and the first antenna element may simultaneously receive and transmit signals, to improve strength of a signal transmitted by the antenna assembly, and improve communication quality.

According to another aspect, embodiments of this disclosure further provide a vehicle, including the foregoing antenna assembly.

In some embodiments that may include the foregoing embodiments, the vehicle includes a vehicle body, and a top of the vehicle body includes a reflection element. In this way, the reflection element may reflect, to an upper part of the vehicle body, a signal that is generated by the antenna element and that is transmitted to a cab and a passenger cabin, to improve signal strength of the upper part of the vehicle body, so as to improve communication quality. In addition, compared with a case in which the reflection element is not disposed, a case in which the reflection element reflects the signal to the upper part of the vehicle body can avoid a signal loss caused by signal transmission to the vehicle body and the ground, and further improve efficiency of the antenna assembly.

In some embodiments that may include the foregoing embodiments, the reflection element and the vehicle body may be an integrated structure. Correspondingly, the reflection element and the vehicle body may be manufactured in a same factory and formed simultaneously.

In some embodiments that may include the foregoing embodiments, the reflection element may alternatively be connected to the vehicle body in a manner of welding, bolt connection, riveting, or the like. Correspondingly, the reflection element and the vehicle body may be manufactured in different factories, and the reflection element is mounted on the vehicle body after being manufactured.

In some embodiments that may include the foregoing embodiments, the antenna assembly includes a first antenna assembly and a second antenna assembly, and both the first antenna assembly and the second antenna assembly are disposed at a front end of the vehicle body in a longitudinal direction. This disposition can improve signal strength of the front end of the vehicle body in the longitudinal direction.

In some embodiments that may include the foregoing embodiments, the antenna assembly includes a first antenna assembly and a second antenna assembly, and both the first antenna assembly and the second antenna assembly are disposed at a rear end of the vehicle body in a longitudinal direction. This disposition can improve signal strength of the rear end of the vehicle body in the longitudinal direction.

In some embodiments that may include the foregoing embodiments, the antenna assembly includes a first antenna assembly and a second antenna assembly, the first antenna assembly is disposed at a front end of the vehicle body in a longitudinal direction, and the second antenna assembly is disposed at a rear end of the vehicle body in the longitudinal direction. This disposition can ensure that the front end and the rear end of the vehicle body in the longitudinal direction each have specific signal strength.

In some embodiments that may include the foregoing embodiments, the antenna assembly includes a first antenna assembly and a second antenna assembly, the first antenna assembly is disposed at one end of the vehicle body in a horizontal direction, and the second antenna assembly is disposed at the other end of the vehicle body in the horizontal direction. This disposition can ensure that two ends of the vehicle body in the horizontal direction each have specific signal strength.

According to one aspect, embodiments of this disclosure further provide a signal transmitting apparatus, including the foregoing antenna assembly.

### BRIEF DESCRIPTION OF DRAWINGS

FIG. 1 is a diagram of a structure of an antenna assembly according to an embodiment;

FIG. 2 is a diagram of a structure of a vehicle according to an embodiment;

FIG. 3 is a top view of a vehicle according to an embodiment;

FIG. 4 is a diagram of a structure of an antenna assembly according to an embodiment;

FIG. 5 is a diagram of a structure of an antenna assembly according to an embodiment;

FIG. 6 is a diagram of a structure of an antenna assembly according to an embodiment;

FIG. 7 is a diagram of a structure of an antenna assembly according to an embodiment;

FIG. 8 is a diagram of a structure of an antenna assembly according to an embodiment;

FIG. 9 is a diagram of a structure of an antenna assembly according to an embodiment;

FIG. 10 is a diagram of a structure of a first antenna element according to an embodiment;

FIG. 11 is a diagram of a structure of a first antenna element according to an embodiment;

FIG. 12 is a diagram of a structure of a first antenna element according to an embodiment;

FIG. 13 is a diagram of a structure of a first antenna element according to an embodiment;

FIG. 14 is a diagram of a structure of a first antenna element according to an embodiment;

FIG. 15 is a diagram of a structure of a first antenna element according to an embodiment;

FIG. 16 is a diagram of a structure of a first antenna element according to an embodiment;

FIG. 17 is a diagram of a structure of a first antenna element according to an embodiment;

FIG. 18 is a diagram of a structure of a first antenna element according to an embodiment;

FIG. 19 is a diagram of a structure of an antenna assembly according to an embodiment;

FIG. 20 is a diagram of a structure of an antenna assembly according to an embodiment;

FIG. 21 is a diagram of a structure of an antenna assembly according to an embodiment;

FIG. 22 is a diagram of a structure of an antenna assembly according to an embodiment;

FIG. 23 is a diagram of a structure of an antenna assembly according to an embodiment;

FIG. 24 is a diagram of a structure of an antenna assembly according to an embodiment;

FIG. 25 is a diagram of a structure of an antenna assembly according to an embodiment;

FIG. 26 is a diagram of a structure of an antenna assembly according to an embodiment;

FIG. 27 is a diagram of a connection between a vehicle body and a reflection element according to an embodiment;

FIG. 28 is a top view of a vehicle according to an embodiment;

FIG. 29 is a top view of a vehicle according to an embodiment;

FIG. 30 is a top view of a vehicle according to an embodiment;

FIG. 31 is a top view of a vehicle according to an embodiment;

FIG. 32 is a top view of a vehicle according to an embodiment;

FIG. 33 is a top view of a vehicle according to an embodiment;

FIG. 34 is a top view of a vehicle according to an embodiment;

FIG. 35 is a top view of a vehicle according to an embodiment;

FIG. 36 is a top view of a vehicle according to an embodiment;

FIG. 37 is a top view of a vehicle according to an embodiment;

FIG. 38 is a top view of a vehicle according to an embodiment;

FIG. 39 is a top view of a vehicle according to an embodiment;

FIG. 40 is a top view of a vehicle according to an embodiment;

FIG. 41 is a diagram of a standing wave ratio of an antenna assembly according to an embodiment;

FIG. 42 is a diagram of efficiency of an antenna assembly according to an embodiment; and

FIG. 43 is a diagram of a direction of an antenna assembly according to an embodiment.

Descriptions of reference numerals: 10: antenna assembly; 101: first dielectric layer; 102: second dielectric layer; 103: intermediate dielectric layer; 104: first antenna element; 105: second antenna element; 106: third antenna element; 107: feed line; 110: reflection element; 111: reflection plate; 112: guide structure; 113: guide protrusion; 114: guide groove; 115: through hole; 116: dielectric layer; 1004: first horizontal monopole antenna; 1014: second horizontal monopole antenna; 1024: third horizontal monopole antenna; 1034: first planar loop antenna; 1044: second planar loop antenna; 1041: first branch; 1042: second branch; 1043: conductive loop; 10431: gap; 1045: conductive branch; 1046: conductive line; 1047: conductive substrate; 1048: conductive plate; 1049: dielectric plate; 1051: first conductor; 1052: second conductor; 1053: third conductor; 1056: metal plate; 1055: slot; 20: vehicle body; 201: sunroof, 202: front shielding window; 203: rear shielding window; 204: front vehicle door; 205: rear vehicle door; 206: vehicle window; 207: quarter window; 30: first antenna assembly; 40: second antenna assembly; 50: third antenna assembly; 60: fourth antenna assembly.

### DESCRIPTION OF EMBODIMENTS

The following describes technical solutions in embodiments of this disclosure with reference to the accompanying drawings in embodiments. It is clear that the described embodiments are merely a part rather than all of embodiments of this disclosure.

Terms “first”, “second”, and the like are merely intended for a purpose of description, and shall not be understood as an indication or implication of relative importance or implicit indication of a quantity of indicated technical features. Therefore, features defined with “first”, “second”, and the like may explicitly or implicitly include one or more such features.

In addition, in embodiments of this disclosure, direction terms such as “up”, “down”, “left”, “right”, “horizontal”, and “vertical” are defined relative to directions and locations in which components in the accompanying drawings are schematically placed. It should be understood that these directional terms are relative concepts, are used for relative description and clarification, and may correspondingly change based on changes in the directions and locations in which the components in the accompanying drawings are placed.

In embodiments of this disclosure, unless otherwise clearly specified and limited, a term “connection” should be understood in a broad sense. For example, the “connection” may be a fixed connection, a detachable connection, or an integral connection, may be a direct connection, or may be an indirect connection through an intermediate medium.

### Embodiment 1

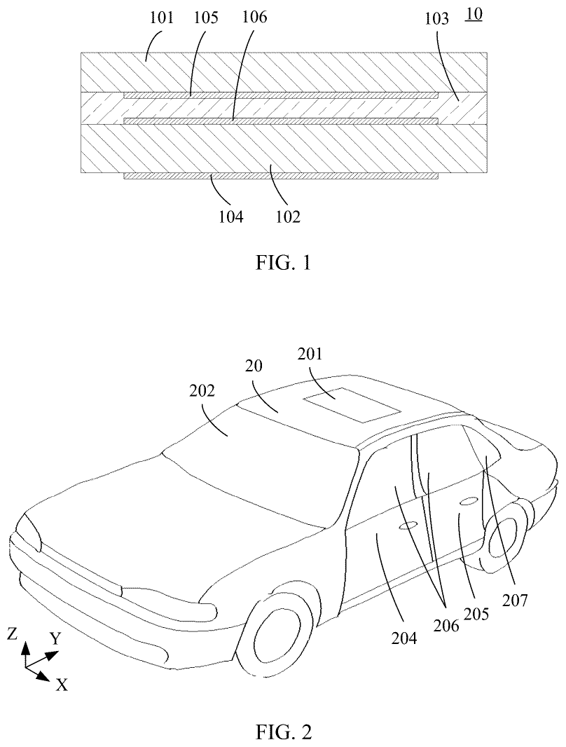

As shown in FIG. 1, an embodiment provides an antenna assembly 10. The antenna assembly 10 may be used in a device like a vehicle, an airplane, a ship, or a mobile phone, to implement communication with an external device through the antenna assembly 10. An application scenario of the antenna assembly 10 is not limited in embodiments.

The antenna assembly 10 includes a first dielectric layer 101 and a second dielectric layer 102 that are laminated, and an intermediate dielectric layer 103 that is laminated between the first dielectric layer 101 and the second dielectric layer 102. In other words, the first dielectric layer 101, the intermediate dielectric layer 103, and the second dielectric layer 102 are sequentially laminated, to form a plate-shaped structure. It may be understood that the plate-shaped structure may be in a flat shape. The plate-shaped structure may alternatively be bent or folded into a specific shape.

The antenna assembly 10 further includes: a first antenna element 104, a second antenna element 105, and a third antenna element 106. The first antenna element 104 is disposed on a surface that is of the second dielectric layer 102 and that is away from the first dielectric layer 101, the second antenna element 105 is disposed between the first dielectric layer 101 and the intermediate dielectric layer 103, and a third dielectric layer is disposed between the intermediate dielectric layer 103 and the second dielectric layer 102. The first antenna element 104, the second antenna element 105, and the third antenna element 106 all may transmit a signal to the outside, and all may receive a signal from the outside.

In some embodiments, the antenna assembly 10 may include a feed line. The feed line is electrically connected to the first antenna element 104, to feed the first antenna element 104 through the feed line. The first antenna element 104 may be configured to couple a signal to the second antenna element 105 and the third antenna element 106, that is, the first antenna element 104 feeds the second antenna element 105 and the second antenna element 105 in a wireless manner. This disposition can reduce a quantity of wires of the antenna assembly 10 and complexity of routing layout, and can further reduce a weight of the antenna assembly 10, to implement lightweight of the antenna assembly 10.

In another embodiment, the antenna assembly 10 may include three feed lines. The first antenna element 104, the second antenna element 105, and the third antenna element 106 each are electrically connected to one feed line, that is, the first antenna element 104, the second antenna element 105, and the third antenna element 106 are fed through different feed lines.

It may be understood that the first dielectric layer 101, the second dielectric layer 102, and the intermediate dielectric layer 103 may all allow a signal to pass through, to prevent the first dielectric layer 101, the second dielectric layer 102, and the intermediate dielectric layer 103 from blocking signal transmission, so as to avoid a signal loss.

In an implementation in which the antenna assembly 10 is used in the vehicle, the vehicle may be an electric vehicle or a gasoline vehicle. This is not limited in embodiments. As shown in FIG. 2, the vehicle includes a vehicle body 20, a cab and a passenger cabin are enclosed by the vehicle body 20, a driver is in the cab, a passenger is in the passenger cabin, and the vehicle body 20 is configured to carry the driver and the passenger.

In the implementation, the antenna assembly 10 may be used in different locations on the vehicle, which may be described in a plurality of scenarios in the following.

### Scenario 1

As shown in FIG. 2, a top of the vehicle body 20 is provided with a sunroof 201, and a plate body including the first dielectric layer 101, the second dielectric layer 102, and the intermediate dielectric layer 103 shown in FIG. 1 may cover the sunroof 201, to seal the sunroof 201. It may be understood that, in this case, the first dielectric layer 101, the second dielectric layer 102, and the intermediate dielectric layer 103 each need to have a specific light transmittance, so that after passing through the first dielectric layer 101, the second dielectric layer 102, and the intermediate dielectric layer 103, external light enters the cab and the passenger cabin, to improve a lighting effect of the passenger cabin.

Based on the foregoing disposition, the first antenna element 104, the second antenna element 105, and the third antenna element 106 are located on the top of the vehicle body 20. After the first antenna element 104, the second antenna element 105, and the third antenna element 106 generate a signal, the signal is directly transmitted to an upper part of the vehicle body 20, so that another structure of the vehicle body 20 can be prevented from blocking the signal, to reduce a signal loss and improve efficiency of the antenna assembly 10.

For example, the second dielectric layer 102 may be disposed close to the cab of the vehicle. This disposition can prevent the first antenna element 104 from being exposed to an external environment, and further prevent the first antenna element 104 from being damaged.

### Scenario 2

Still as shown in FIG. 2, a front end of the vehicle body 20 in a longitudinal direction (a direction Y in FIG. 2) is provided with a front shielding window 202, and a plate body including the first dielectric layer 101, the second dielectric layer 102, and the intermediate dielectric layer 103 may cover the front shielding window 202, to seal the front shielding window 202. It may be understood that, in this case, the first dielectric layer 101, the second dielectric layer 102, and the intermediate dielectric layer 103 each need to have a specific light transmittance, so that the driver can observe a road surface in front of the vehicle through the front shielding window 202, to help drive the vehicle. In this case, the first antenna element 104, the second antenna element 105, and the third antenna element 106 are located at the front end of the vehicle body 20 in the longitudinal direction, so that signal strength of the front end of the vehicle body 20 in the longitudinal direction can be improved.

### Scenario 3

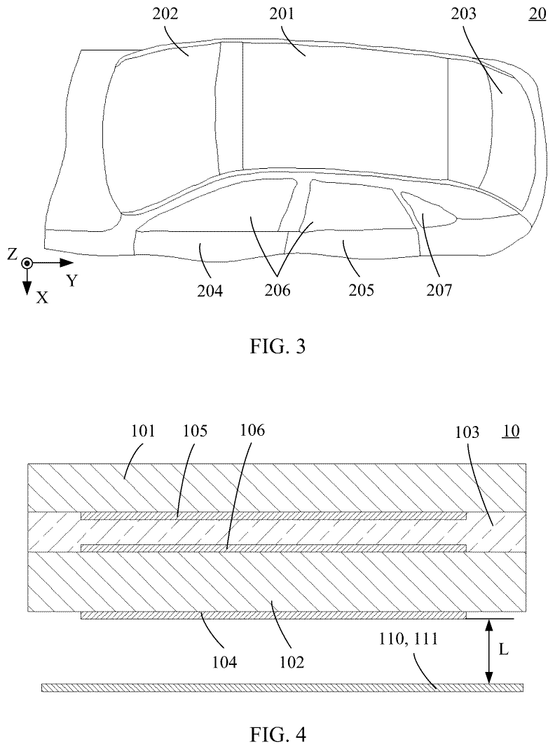

As shown in FIG. 3, a rear end of the vehicle body 20 in a longitudinal direction is provided with a rear shielding window 203, and a plate body including the first dielectric layer 101, the second dielectric layer 102, and the intermediate dielectric layer 103 shown in FIG. 1 may cover the rear shielding window 203, to seal the rear shielding window 203. It may be understood that, in this case, the first dielectric layer 101, the second dielectric layer 102, and the intermediate dielectric layer 103 each need to have a specific light transmittance, and light may enter the passenger cabin through the rear shielding window 203. In this case, the first antenna element 104, the second antenna element 105, and the third antenna element 106 are located at the rear end of the vehicle body 20 in the longitudinal direction, so that signal strength of the rear end of the vehicle body 20 in the longitudinal direction can be improved.

### Scenario 4

Still as shown in FIG. 2, the vehicle body 20 is provided with a front vehicle door 204 and a rear vehicle door 205, and each of the front vehicle door 204 and the rear vehicle door 205 is provided with a vehicle window 206. Correspondingly, a plate body including the first dielectric layer 101, the second dielectric layer 102, and the intermediate dielectric layer 103 shown in FIG. 1 may cover the vehicle window 206, to seal the vehicle window 206. It may be understood that the first dielectric layer 101, the second dielectric layer 102, and the intermediate dielectric layer 103 each need to have a specific light transmittance, and light may enter the cab and the passenger cabin through the vehicle window 206. In this case, the first antenna element 104, the second antenna element 105, and the third antenna element 106 are located at one end of the vehicle body 20 in a horizontal direction, so that signal strength of the one end of the vehicle body 20 in the horizontal direction can be improved.

### Scenario 5

Still as shown in FIG. 2, a front vehicle door 204 and a rear vehicle door 205 are provided on the vehicle body 20, and a quarter window 207 is provided on a rear side of the rear vehicle door 205. Correspondingly, a plate body including the first dielectric layer 101, the second dielectric layer 102, and the intermediate dielectric layer 103 shown in FIG. 1 may cover the quarter window 207, to seal the quarter window 207. It may be understood that, in this case, the first dielectric layer 101, the second dielectric layer 102, and the intermediate dielectric layer 103 each need to have a specific light transmittance, and light may enter the cab and the passenger cabin through the quarter window 207. In this case, the first antenna element 104, the second antenna element 105, and the third antenna element 106 may transmit a signal to the outside at a location of the quarter window.

In the foregoing scenarios, both the first dielectric layer 101 and the second dielectric layer 102 may be glass layers, the intermediate dielectric layer 103 may be a connection adhesive layer, and the connection adhesive layer is bonded to the first dielectric layer 101 and the second dielectric layer 102, to implement a connection between the first dielectric layer 101 and the second dielectric layer 102. The first dielectric layer 101, the second dielectric layer 102, and the intermediate dielectric layer 103 each may be a plastic layer or the like. Materials of the first dielectric layer 101, the second dielectric layer 102, and the intermediate dielectric layer 103 are not limited in embodiments.

In the foregoing scenarios, the plate body including the first dielectric layer 101, the second dielectric layer 102, and the intermediate dielectric layer 103 may cover the front shielding window 202, the sunroof 201, and the rear shielding window 203 on the vehicle body 20 (as shown in FIG. 3). In this case, the plate body forms a canopy structure, so that an area of the sunroof 201 can be increased, to increase an amount of light in the cab and the passenger cabin. Correspondingly, the first antenna element 104, the second antenna element 105, and the third antenna element 106 may be disposed at a location corresponding to the front shielding window 202, or the first antenna element 104, the second antenna element 105, and the third antenna element 106 may be disposed at a location corresponding to the sunroof 201, or the first antenna element 104, the second antenna element 105, and the third antenna element 106 may be disposed at a location corresponding to the rear shielding window 203. The first antenna element 104, the second antenna element 105, and the third antenna element 106 may alternatively be disposed at locations corresponding to two or three of the front shielding window 202, the sunroof 201, and the rear shielding window 203.

In an implementation in which the antenna assembly 10 is used in the ship or the aircraft, the plate body including the first dielectric layer 101, the second dielectric layer 102, and the intermediate dielectric layer 103 may cover a window of the ship or the aircraft. The plate body including the first dielectric layer 101, the second dielectric layer 102, and the intermediate dielectric layer 103 may alternatively be disposed at another location. This is not limited in embodiments.

In an implementation in which the antenna assembly 10 is used in an electronic device like the mobile phone or a tablet computer, a display panel is disposed in the electronic device like the mobile phone or the tablet computer, and the first dielectric layer 101, the second dielectric layer 102, and the intermediate dielectric layer 103 may be film layers in the display panel. In this way, the display panel can transmit a signal to the outside, and can also receive a signal from the outside.

Still as shown in FIG. 1, in the antenna assembly 10 provided in this embodiment, the first antenna element 104 is disposed on the surface that is of the second dielectric layer 102 and that is away from the first dielectric layer 101, the second antenna element 105 is disposed between the intermediate dielectric layer 103 and the first dielectric layer 101, and the third antenna element 106 is disposed between the intermediate dielectric layer 103 and the second dielectric layer 102. During operation, the first antenna element 104, the second antenna element 105, and the third antenna element 106 all transmit a signal to the outside, so that signal transmitting strength of the antenna assembly 10 can be improved, to improve communication quality of the antenna assembly 10.

As shown in FIG. 4, the antenna assembly 10 in this embodiment further includes a reflection element 110. The reflection element 110 is located on a side that is of the second dielectric layer 102 and that is away from the first dielectric layer 101, and the reflection element 110 is configured to reflect a signal transmitted by the first antenna element 104, the second antenna element 105, and the third antenna element 106 to the reflection element 110. In this disposition, after being reflected on the reflection element 110, the signal may be transmitted in a direction that is of the first dielectric layer 101 and that is away from the reflection element 110, so that a radiation pattern of the antenna assembly 10 is hemispherical. Compared with a spherical radiation pattern of the antenna assembly 10, the signal transmitted to the reflection element 110 may be reflected to a side that is of the first dielectric layer 101 and that is away from the reflection element 110, to improve signal strength of the side that is of the first dielectric layer 101 and that is away from the reflection element 110, so as to improve communication quality.

It may be understood that, when a location of the antenna assembly 10 is properly disposed, the first dielectric layer 101 may be disposed to face a communication region, so that all signals are transmitted to the communication region, and a case in which a part of the signals is transmitted to a non-communication region (for example, the ground) may be prevented, to reduce a signal loss, so as to improve efficiency of the antenna assembly 10.

For example, in an implementation in which the antenna assembly 10 is disposed on the sunroof 201 shown in FIG. 2 of the vehicle, the reflection element 110 may be disposed on a side (an inner side) that is of the second dielectric layer 102 and that is close to the cab and the passenger cabin. In this case, the reflection element 110 may reflect, to upper part space of the vehicle body 20 (communication region), a signal transmitted by the first antenna element 104, the second antenna element 105, and the third antenna element 106 to the cab and the passenger cabin, to prevent the signal transmitted to the cab and the passenger cabin from being blocked by the vehicle body 20 and the ground, so as to improve efficiency of the antenna assembly 10.

In some implementations, in projections on the intermediate dielectric layer 103, a projection of the reflection element 110 covers all projections of the first antenna element 104, the second antenna element 105, and the third antenna element 106. In other words, in the projections on the intermediate dielectric layer 103, the projections of the first antenna element 104, the second antenna element 105, and the third antenna element 106 are all located in the projection of the reflection element 110. In this disposition, all signals that are generated by the first antenna element 104, the second antenna element 105, and the third antenna element 106 and that are transmitted to the reflection element 110 may be reflected on the reflection element 110, to avoid a signal loss caused when a part of the signals is not reflected by the reflection element 110.

In another implementation, in projections on the intermediate dielectric layer 103, a projection of the reflection element 110 covers a projection of a part of the first antenna element 104, a projection of a part of the second antenna element 105, and a projection of a part of the third antenna element 106. In other words, the projection of the part of the first antenna element 104, the projection of the part of the second antenna element 105, and the projection of the part of the third antenna element 106 are located in the projection of the reflection element 110. In this disposition, the reflection element 110 may reflect a specific signal (for example, a signal with a specific frequency) generated by the first antenna element 104, the second antenna element 105, and the third antenna element 106, to enhance signal strength of the specific signal.

In the foregoing implementation, there is a first distance L between the reflection element 110 and the first antenna element 104, and the first distance L is a distance at which a signal is transferred from the first antenna element 104 to the reflection element 110. The first distance L is properly set, to improve a reflection effect of the reflection element 110 on a signal.

For example, the first distance L may be 0.05 to 1 times a wavelength of the signal transmitted by the first antenna element 104, the second antenna element 105, and the third antenna element 106. For example, the first distance L may be 0.1 to 0.5 times the wavelength of the signal transmitted by the first antenna element 104, the second antenna element 105, and the third antenna element 106. For example, the first distance L may be 0.1, 0.3, 0.5, or the like times the wavelength of the signal transmitted by the first antenna element 104, the second antenna element 105, and the third antenna element 106. In this disposition, a reflection effect of the reflection element 110 on the signal transmitted by the first antenna element 104, the second antenna element 105, and the third antenna element 106 can be improved.

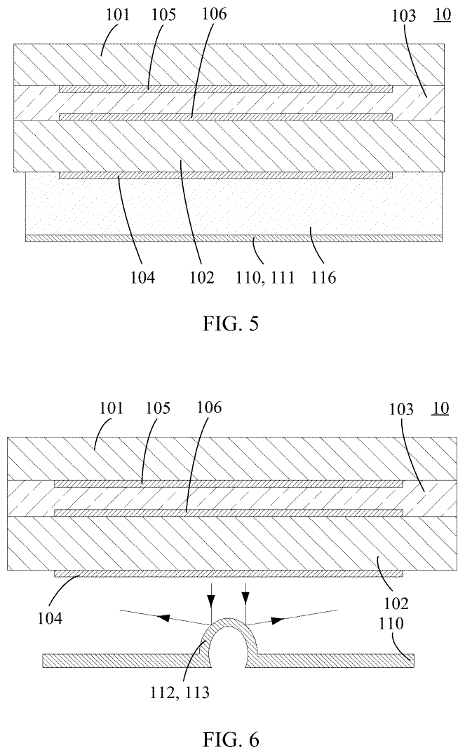

In some embodiments, as shown in FIG. 5, a dielectric layer 116 is disposed between the reflection element 110 and the first antenna element 104, and the dielectric layer 116 may fill space between the reflection element 110 and the first antenna element 104; or the dielectric layer 116 is located only in a part of a region between the first antenna element 104 and the reflection element 110. A dielectric constant of the dielectric layer 116 is properly set, so that when there are different first distances between the reflection element 110 and the first antenna element 104, the reflection element 110 can always reflect a signal of the first antenna element 104. Flexibility of the first distance between the reflection element 110 and the first antenna element 104 is enhanced. For example, a material of the dielectric layer 116 may be plastic, rubber, or ceramic.

Still as shown in FIG. 4, in this embodiment, the reflection element 110 may include a reflection plate 111, and the reflection plate 111 and the second dielectric layer 102 are disposed at a spacing. The reflection plate 111 may be parallel to a plane in which the second dielectric layer 102 is located, or there is a specific included angle between the reflection plate 111 and the plane in which the second dielectric layer 102 is located. Signal reflection is performed on the reflection plate 111. In this way, a structure is simple, and manufacturing is easy.

In another implementation, the reflection element 110 may include a reflector, and the reflector is provided with a groove. A signal may be reflected on a groove wall of the groove, and is transmitted to the side that is of the first dielectric layer 101 and that is away from the reflection element 110.

In an implementation in which the antenna assembly 10 is used in the vehicle, the reflection element 110 may be located on a side that is of the second dielectric layer 102 and that faces the inside of the vehicle. In other words, the first dielectric layer 101 is exposed outside the vehicle body 20 shown in FIG. 2, the second dielectric layer 102 is disposed to face the inside of the vehicle body 20, and the reflection element 110 is located on the side inside the second dielectric layer 102. This disposition can prevent another external object from entering between the reflection element 110 and the second dielectric layer 102, to avoid affecting signal reflection.

As shown in FIG. 6, in the foregoing implementation, a guide structure 112 is disposed on the reflection element 110, and the guide structure 112 is configured to reflect a signal towards a first direction. This disposition can improve signal strength in the first direction, and further improve communication quality.

It may be understood that, the first direction may be properly set based on an actual communication requirement. For example, in an implementation in which the antenna assembly is disposed on the vehicle body 20 shown in FIG. 2, the first direction may be a forward direction (a reverse direction of the direction Y) of the vehicle body 20 in the longitudinal direction, or the first direction is a direction (a reverse direction that is of the direction Y and that is inclined to a direction Z) that is forward in the longitudinal direction of the vehicle body 20 and that is upward inclined. The first direction may alternatively be a backward direction (the direction Y) of the vehicle body 20 in the longitudinal direction, or the first direction is a direction (which is in a direction Y and inclined to the direction Z) that is backward in the longitudinal direction of the vehicle body 20 and that is upward inclined. The first direction may alternatively be another direction, and this is not limited in embodiments.

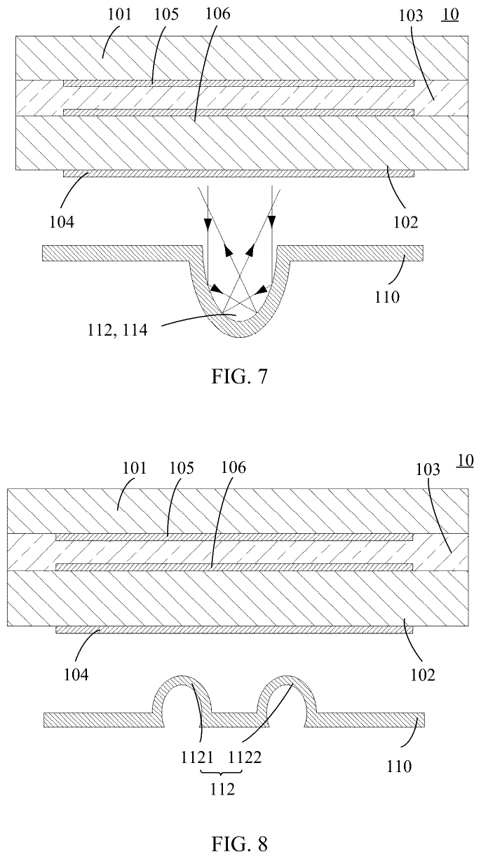

For example, as shown in FIG. 6 and FIG. 7, the guide structure 112 may include a guide protrusion 113 and/or a guide groove 114 that are/is provided on the reflection element 110. In this disposition, the guide protrusion 113 and/or the guide groove 114 are/is provided on the reflection element 110, so that a signal is transmitted towards the first direction after being reflected. In this way, a structure is simple, and manufacturing is easy.

As shown in FIG. 6, in an implementation in which the guide structure 112 includes the guide protrusion 113 disposed on the reflection element 110, the guide protrusion 113 is disposed on a surface that is of the reflection element 110 and that faces the first antenna element 104. The guide protrusion 113 has a reflection surface close to the first antenna element 104. The reflection surface may be a curved surface. Correspondingly, a curvature of the reflection surface is properly set, so that a signal is transmitted towards the first direction after being reflected on the reflection surface. The reflection surface may alternatively be an inclined surface inclined relative to the second dielectric layer 102. Correspondingly, an angle between the inclined surface and the second dielectric layer 102 is properly set, so that a signal can be transmitted towards the first direction after being reflected on the reflection surface.

As shown in FIG. 7, in an implementation in which the guide structure 112 includes the guide groove 114 disposed on the reflection element 110, the guide groove 114 is disposed on a surface that is of the reflection element 110 and that faces the first antenna element 104. A groove wall of the guide groove 114 may be a curved surface. Correspondingly, a curvature of the groove wall is properly set, so that a signal is transmitted towards the first direction after being reflected on the groove wall. The groove wall of the guide groove 114 may alternatively be an inclined surface inclined relative to the second dielectric layer 102. Correspondingly, an angle between the groove wall and the second dielectric layer 102 is properly set, so that a signal can be transmitted towards the first direction after being reflected on the groove wall of the guide groove 114.

In an implementation in which the guide structure 112 includes the guide protrusion 113 and the guide groove 114 that are provided on the reflection element 110, structures of the guide protrusion 113 and the guide groove 114 may be roughly the same as structures in the foregoing implementations, and details are not described herein again.

As shown in FIG. 8, in this embodiment, the guide structure 112 includes a first guide structure 1121 and a second guide structure 1122. The first guide structure 1121 and the second guide structure 1122 are disposed on the reflection element 110 at a spacing. In this disposition, more signals can be reflected towards the first direction, to further improve signal strength in the first direction. It may be understood that a quantity of the guide structures 112 is not limited to 2, and the quantity of the guide structures 112 may be 3, 4, or the like. A plurality of guide structures 112 may be arranged on the reflection element 110 in an array, or a plurality of guide structures 112 may be arranged on the reflection element 110 irregularly.

In the foregoing implementation, the guide structure 112 and the reflection element 110 may be an integrated structure, that is, the guide structure 112 and the reflection element 110 are integrated by using a process like stamping or casting, to reduce manufacturing difficulty of the antenna assembly 10. The guide structure 112 may alternatively be connected to the reflection element 110 in a manner of welding, riveting, bolt connection, clamping, or the like. Correspondingly, the reflection element 110 and the guide structure 112 may be separately manufactured, and then the guide structure 112 is mounted on the reflection element 110.

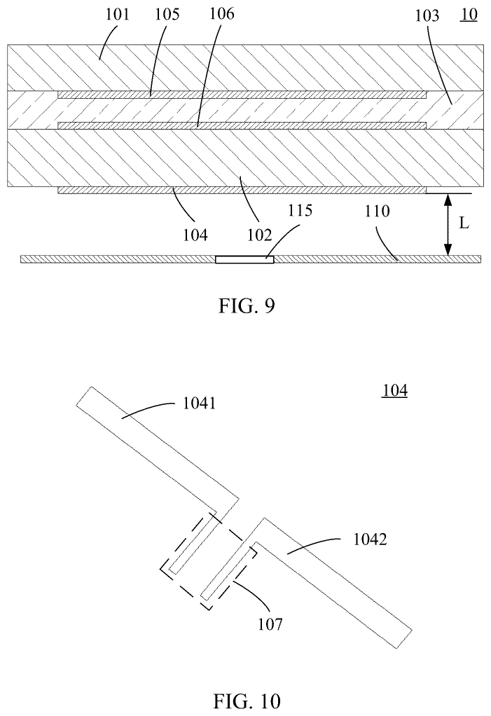

As shown in FIG. 9, in some embodiments, the reflection element 110 is provided with a through hole 115, so that the reflection element 110 forms a slot antenna. In this case, the first antenna element 104 may couple a signal to the slot antenna, so that the slot antenna, the first antenna element 104, the second antenna element 105, and the third antenna element 106 all can transmit a signal to the outside, to improve signal strength, and further improve communication quality.

It may be understood that, a shape of a hole wall of the through hole 115 is properly set, so that a signal transmitted by the first antenna element 104, the second antenna element 105, and the third antenna element 106 to the reflection element 110 can be reflected on the hole wall of the through hole 115, and the reflected signal is transmitted towards the first direction, to improve signal strength in the first direction.

Still as shown in FIG. 4, in this embodiment, in an implementation in which the antenna assembly 10 is used in the vehicle, the reflection element 110 and the vehicle body 20 shown in FIG. 2 may be an integrated structure. Correspondingly, the reflection element 110 and the vehicle body 20 may be manufactured in a same factory and formed simultaneously. Alternatively, the reflection element 110 may be connected to the vehicle body 20 in a manner of welding, bolt connection, riveting, or the like. Correspondingly, the reflection element 110 and the vehicle body 20 may be manufactured in different factories, and the reflection element 110 is mounted on the vehicle body 20 after being manufactured.

In this embodiment, the antenna assembly 10 may communicate with a communication base station. The antenna assembly 10 may further communicate with a positioning system (for example, a global positioning system (GPS) or a BeiDou positioning system), to implement positioning and navigation. The antenna assembly 10 may further receive a frequency modulation broadcast signal, to listen to a broadcast program. The antenna assembly 10 in this embodiment may further communicate with another external device, and this is not limited in embodiments.

It may be understood that a frequency of the antenna assembly 10 may cover a communication frequency band of a cellular antenna (CELL antenna), to meet requirements such as call, internet access, and positioning. The frequency of the antenna assembly 10 may be 0.69 gigaHertz (GHz) to 6 GHz, so that the antenna assembly 10 has a large bandwidth. For example, when the frequency of the antenna assembly 10 is 0.7 GHz to 1 GHz, a requirement for low-frequency communication, for example, a 2G network communication requirement, may be met; when the frequency of the antenna assembly 10 is 1.7 GHz to 2.7 GHz, a requirement for 3G and 4G network communication may be met, and a requirement for communication with a positioning system may also be met; and when the frequency of the antenna assembly 10 is 3.2 GHz to 6 GHz, a requirement for high-frequency communication, for example, a requirement for 5G network communication may be met.

In this embodiment, the first antenna element 104 may be of a plurality of structures, provided that signal transmission and reception can be implemented. The following separately describes the plurality of structures of the first antenna element 104.

### Structure 1

As shown in FIG. 10, the first antenna element 104 may be a horizontal dipole antenna. For example, the first antenna element 104 includes a first branch 1041 and a second branch 1042 that are disposed opposite to each other, the first branch 1041 and the second branch 1042 extend in reverse directions, a feed line 107 may include a coaxial cable, a core wire in the coaxial cable is connected to one end that is of the first branch 1041 and that is close to the second branch 1042, and a shield layer of the coaxial cable is connected to one end that is of the second branch 1042 and that is close to the first branch 1041.

### Structure 2

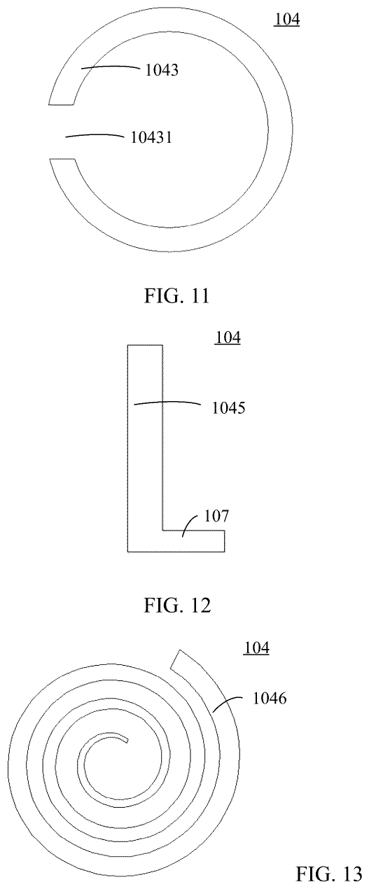

As shown in FIG. 11, the first antenna element 104 may be a planar loop antenna. For example, the first antenna element 104 includes a conductive loop 1043, where the conductive loop 1043 is provided with a gap 10431, and the gap 10431 breaks the conductive loop 1043. A feed line may include a coaxial cable. The conductive loop 1043 on one side of the gap 10431 is connected to a core wire of the coaxial cable, and the conductive loop 1043 on the other side of the gap 10431 is connected to a shield layer of the coaxial cable.

### Structure 3

As shown in FIG. 12, the first antenna element 104 may be a horizontal monopole antenna. For example, the first antenna element 104 may include a conductive branch 1045, and one end of the conductive branch 1045 is connected to a feed line 107.

### Structure 4

As shown in FIG. 13, the first antenna element 104 may be a planar helical antenna. For example, the first antenna element 104 may include a conductive wire 1046 that extends in a helix shape around a first axis. A feed line may include a coaxial cable. One end that is of the conductive wire 1046 and that is close to the first axis may be connected to a core wire of the coaxial cable, and one end that is of the conductive wire 1046 and that is away from a preset axis may be connected to a shield layer of the coaxial cable.

### Structure 5

As shown in FIG. 14, the first antenna element 104 may be a patch antenna. For example, the first antenna element 104 may include a conductive substrate 1047, a dielectric plate 1049, and a conductive plate 1048 that are sequentially laminated. A projection of the conductive plate 1048 on the dielectric plate 1049 is located in a projection of the conductive substrate 1047 on the dielectric plate 1049. A feed line may include a coaxial cable, a core wire of the coaxial cable is connected to the conductive plate 1048, and a shield layer of the coaxial cable is connected to the substrate.

### Structure 6

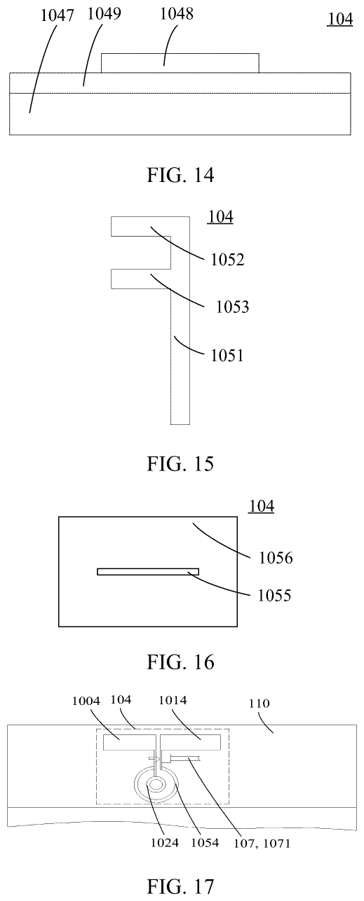

As shown in FIG. 15, the first antenna element 104 may be an inverted F antenna. For example, the first antenna element 104 may include a first conductor 1051 extending in the first direction, a second conductor 1052 extending in a second direction, and a third conductor 1053 extending in the second direction. One end of the second conductor 1052 is connected to one end of the first conductor 1051, one end of the third conductor 1053 is connected to the first conductor 1051, the third conductor is connected to a feed line, and the second conductor 1052 is grounded.

### Structure 7

As shown in FIG. 16, the first antenna element 104 may alternatively be the slot antenna. For example, the first antenna element 104 includes a metal plate 1056, the metal plate 1056 is provided with a slot 1055, and a feed line is connected to the metal plate 1056.

It may be understood that the first antenna element 104 may be one or a combination of the structures.

As shown in FIG. 17, in an implementation in which the first antenna element 104 is a combination of the plurality of structures, for example, the first antenna element 104 may include a first horizontal monopole antenna 1004, a second horizontal monopole antenna 1014, a third horizontal monopole antenna 1024, and a planar loop antenna 1054. A core wire of a coaxial cable 1071 is connected to the first horizontal monopole antenna 1004, the third horizontal monopole antenna 1024, and a conductive loop on one side of a gap of the planar loop antenna 1054, and a shield layer of the coaxial cable 1071 is connected to the second horizontal monopole antenna 1014 and a conductive loop on the other side of the gap of the planar loop antenna 1054. The third horizontal monopole antenna 1024 may be in a loop shape, and the third horizontal monopole antenna 1024 may be located inside the planar loop antenna 1054, so that structural compactness of the first antenna element 104 can be improved.

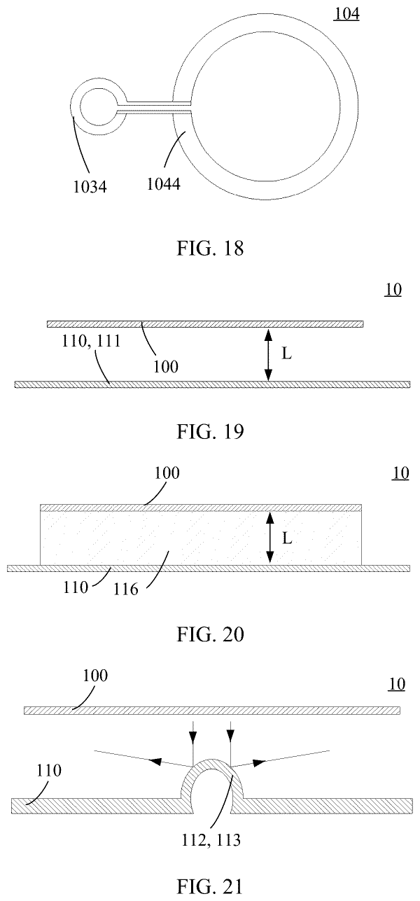

Alternatively, as shown in FIG. 18, the first antenna element 104 includes a first planar loop antenna 1034 and a second planar loop antenna 1044, the core wire of the coaxial cable may be connected to one side of a gap of the first planar loop antenna 1034, and the core wire is further connected to one side of a gap of the second planar loop antenna 1044; the shield layer of the coaxial cable is connected to the other side of the gap of the first planar loop antenna 1034, and the shield layer of the coaxial cable is further connected to the other side of the gap of the second planar loop antenna 1044. In other words, the first planar loop antenna 1034 and the second planar loop antenna 1044 are connected in parallel.

The first antenna element 104 is the combination of the plurality of structures, so that a communication frequency band width of the first antenna element 104 can be improved, to improve a communication effect.

In this embodiment, structures of the second antenna element 105 and the third antenna element 106 may be the same as or different from that of the first antenna element 104, and this is not limited in embodiments.

In this embodiment, the first antenna element 104, the second antenna element 105, and the third antenna element 106 may include a transparent conductive film (like an indium tin oxide film or a transparent silver film), a flexible printed circuit (FPC), and the like. In an implementation in which the first antenna element 104, the second antenna element 105, and the third antenna element 106 each include a transparent conductive film, the first antenna element 104, the second antenna element 105, and the third antenna element 106 that each have a specific shape may be formed in a manner of coating, etching, or the like. In an implementation in which the first antenna element 104, the second antenna element 105, and the third antenna element 106 each include a flexible printed circuit, a plane in which the flexible circuit board is located may be parallel to the intermediate dielectric layer 103. The flexible circuit board may alternatively be bent and disposed on a corresponding dielectric layer.

In another embodiment, alternatively, the first antenna element 104, the second antenna element 105, and the third antenna element 106 each may include a metal film layer. Correspondingly, processing such as etching or cutting may be performed on the metal film layer, to form the first antenna element 104, the second antenna element 105, and the third antenna element 106 that each have a specific shape.

### Embodiment 2

As shown in FIG. 19, an embodiment provides an antenna assembly 10. The antenna assembly 10 may be used in a device like a vehicle, an airplane, a ship, or a mobile phone, to implement communication with an external device through the antenna assembly 10. An application scenario of the antenna assembly 10 is not limited in embodiments.

The antenna assembly 10 includes an antenna element 100 and a reflection element 110. The antenna element 100 is configured to transmit a signal to the outside, and the antenna element 100 may also receive a signal from the outside. The reflection element 110 and the antenna element 100 are disposed at a spacing. The reflection element 110 is configured to reflect a signal transmitted by the antenna element 100 to the reflection element 110. In other words, the signal that is transmitted to the reflection element 110 and that is generated by the antenna element 100 is reflected on the reflection element 110, and the reflected signal is transmitted towards a direction that is of the antenna element 100 and that is away from the reflection element 110.

In this disposition, a signal radiation pattern generated by the antenna element 100 is concentrated on a side that is of the antenna element 100 and that is away from the reflection element 110, and the radiation pattern is hemispherical, so that signal strength on the side that is of the antenna element 100 and that is away from the reflection element 110 is improved, to improve communication quality.

Locations of the antenna element 100 and the reflection element 110 are properly set, so that a signal can be transmitted to a communication region after being reflected by the reflection element 110. For example, after being reflected by the reflection element 110, the signal is transmitted towards a direction away from the ground. Compared with a case in which the reflection element 110 is not disposed, this can avoid a signal loss caused by signal transmission to a location of a non-communication region like the ground, and further improve efficiency of the antenna assembly 10. It may be understood that the communication region may be a region in which signal transmission and signal reception are facilitated, for example, the air away from the ground.

In some embodiments, in a plane in which the antenna element 100 is located, a projection of the reflection element 110 covers a part of the antenna element 100. In other words, in a plane in which the reflection element 110 is located, a projection of the part of the antenna element 100 is located on the reflection element 110. In this disposition, a part of the signal transmitted by the antenna element 100 is reflected on the reflection element 110, so that a specific signal (for example, a signal of a specific frequency) is reflected on the reflection element 110, to enhance signal strength of the specific signal.

In another embodiment, in a plane in which the antenna element 100 is located, a projection of the reflection element 110 covers all the antenna element 100. In other words, in a plane in which the reflection element 110 is located, all projection of the antenna element 100 is located on the reflection element 110. In this disposition, all signals that are generated by the antenna element 100 and that are transmitted to the reflection element 110 are reflected on the reflection element 110, to avoid a signal loss caused when a part of the signals is not reflected by the reflection element 110.

In the foregoing implementation, there is a first distance L between the reflection element 110 and the antenna element 100, and the first distance L is a distance at which a signal is transferred from the antenna element 100 to the reflection element 110. The first distance L is properly set, to improve a reflection effect of the reflection element 110 on a signal.

For example, the first distance L may be 0.05 to 1 times a wavelength of the signal transmitted by the antenna element 100. For example, the first distance L may be 0.1 to 0.5 times a wavelength of the signal transmitted by the antenna assembly 10. For example, the first distance L may be 0.1, 0.3, 0.5, or the like times the wavelength of the signal transmitted by the antenna assembly 10. In this disposition, a reflection effect of the reflection element 110 on the signal transmitted by the antenna element 100 can be improved.

As shown in FIG. 20, in some embodiments, a dielectric layer 116 is disposed between the reflection element 110 and the antenna element 100, and the dielectric layer 116 may fill space between the reflection element 110 and the antenna element 100; or the dielectric layer 116 is located only in a part of a region between the antenna element 100 and the reflection element 110. A dielectric constant of the dielectric layer 116 is properly set, so that when there are different first distances between the reflection element 110 and the antenna element 100, the reflection element 110 can always reflect a signal of the antenna element 100. Flexibility of the first distance between the reflection element 110 and the antenna element 100 is enhanced. For example, a material of the dielectric layer 116 may be plastic, rubber, or ceramic.

Still as shown in FIG. 19, in this embodiment, the reflection element 110 may include a reflection plate 111, and the reflection plate 111 and the antenna element 100 are disposed at a spacing. The reflection plate 111 is parallel to the plane in which the antenna element 100 is located, or there is a specific included angle between the reflection plate 111 and the plane in which the antenna element 100 is located. Signal reflection is performed on the reflection plate 111. In this way, a structure is simple, and manufacturing is easy.

In another implementation, the reflection element 110 may include a reflector, and the reflector is provided with a groove. A signal may be reflected on a groove wall of the groove, and is transmitted to the side that is of the antenna element 100 and that is away from the reflection element 110.

As shown in FIG. 21, in this embodiment, a guide structure 112 is disposed on the reflection element 110, and the guide structure 112 is configured to reflect a signal towards a first direction. This disposition can improve signal strength in the first direction, and further improve communication quality.

It may be understood that, the first direction may be properly set based on an actual communication requirement. For example, in an implementation in which the antenna assembly 10 is used in the vehicle, the vehicle includes the vehicle body 20 (as shown in FIG. 2) that encloses a cab and a passenger cabin, the first direction may be a forward direction (a reverse direction of a direction Y) of the vehicle body 20 in a longitudinal direction, or the first direction is a direction (a reverse direction that is of the direction Y and that is inclined to a direction Z) that is forward in the longitudinal direction of the vehicle body 20 and that is upward inclined. The first direction may alternatively be a backward direction (the direction Y) of the vehicle body 20 in the longitudinal direction, or the first direction is a direction (which is in a direction Y and inclined to the direction Z) that is backward in the longitudinal direction of the vehicle body 20 and that is upward inclined. The first direction may alternatively be another direction, and this is not limited in embodiments.

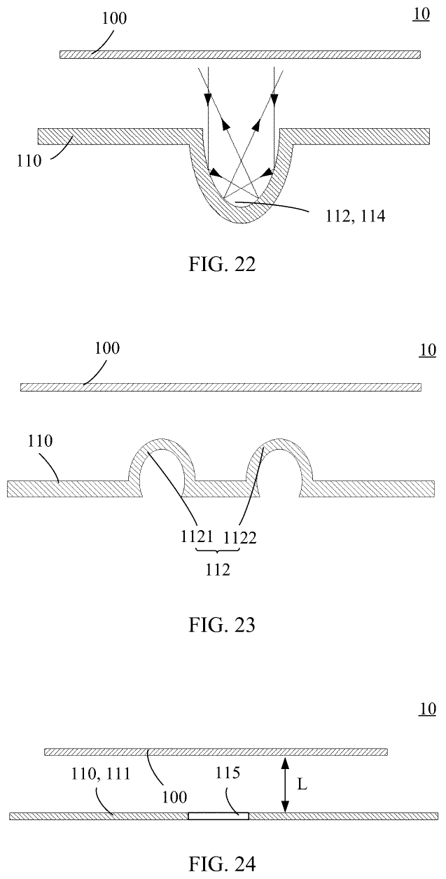

As shown in FIG. 21 and FIG. 22, the guide structure 112 may include a guide protrusion 113 and/or a guide groove 114 that are/is provided on the reflection element 110. In this disposition, the guide protrusion 113 and/or the guide groove 114 are/is provided on the reflection element 110, so that a signal is transmitted towards the first direction after being reflected on the guide structure 112. In this way, a structure is simple, and manufacturing is easy.

Still as shown in FIG. 21, in an implementation in which the guide structure 112 includes the guide protrusion 113 disposed on the reflection element 110, the guide protrusion 113 is disposed on a surface that is of the reflection element 110 and that faces the antenna element 100. The guide protrusion 113 has a reflection surface close to the antenna element 100. The reflection surface may be a curved surface. Correspondingly, a curvature of the reflection surface is properly set, so that a signal is transmitted towards the first direction after being reflected on the reflection surface. The reflection surface may alternatively be an inclined surface inclined relative to the plane in which the antenna element 100 is located. Correspondingly, an angle between the inclined surface and the plane in which the antenna element 100 is located is properly set, so that a signal can be transmitted towards the first direction after being reflected on the reflection surface.

Still as shown in FIG. 22, in an implementation in which the guide structure 112 includes the guide groove 114 disposed on the reflection element 110, the guide groove 114 is disposed on a surface that is of the reflection element 110 and that faces the antenna element 100. A groove wall of the guide groove 114 may be a curved surface. Correspondingly, a curvature of the groove wall is properly set, so that a signal is transmitted towards the first direction after being reflected on the groove wall. The groove wall of the guide groove 114 may alternatively be an inclined surface inclined relative to the plane in which the antenna element 100 is located. Correspondingly, an angle between the groove wall and the plane in which the antenna element 100 is located is properly set, so that a signal can be transmitted towards the first direction after being reflected on the groove wall of the guide groove 114.

In an implementation in which the guide structure 112 includes the guide protrusion 113 and the guide groove 114 that are provided on the reflection element 110, structures of the guide protrusion 113 and the guide groove 114 may be roughly the same as structures in the foregoing implementations, and details are not described herein again.

As shown in FIG. 23, in this embodiment, the guide structure 112 includes a first guide structure 1121 and a second guide structure 1122. The first guide structure 1121 and the second guide structure 1122 are disposed on the reflection element 110 at a spacing. In this disposition, more signals can be reflected towards the first direction, to further improve signal strength in the first direction. It may be understood that a quantity of the guide structures 112 is not limited to 2, and the quantity of the guide structures 112 may be 3, 4, or the like. A plurality of guide structures 112 may be arranged on the reflection element 110 in an array, or a plurality of guide structures 112 may be arranged on the reflection element 110 irregularly.

In the foregoing implementation, the guide structure 112 and the reflection element 110 may be an integrated structure, that is, the guide structure 112 and the reflection element 110 are integrated by using a process like stamping or casting, to reduce manufacturing difficulty of the antenna assembly 10. The guide structure 112 may alternatively be connected to the reflection element 110 in a manner of welding, bolt connection, clamping, or the like. Correspondingly, the reflection element 110 and the guide structure 112 may be separately manufactured, and then the guide structure 112 is mounted on the reflection element 110.

As shown in FIG. 24, in some embodiments, the reflection element 110 is provided with a through hole 115, so that the reflection element 110 forms a slot antenna. In this case, the first antenna element 104 may couple a signal to the slot antenna, so that the slot antenna, the first antenna element 104, the second antenna element 105, and the third antenna element 106 all can transmit a signal to the outside, to improve signal strength, and further improve communication quality.

It may be understood that, a shape of a hole wall of the through hole 115 is properly set, so that a signal transmitted by the antenna element 100 to the reflection element 110 can be reflected on the hole wall of the through hole 115, and the reflected signal is transmitted towards the first direction, to improve signal strength in the first direction.

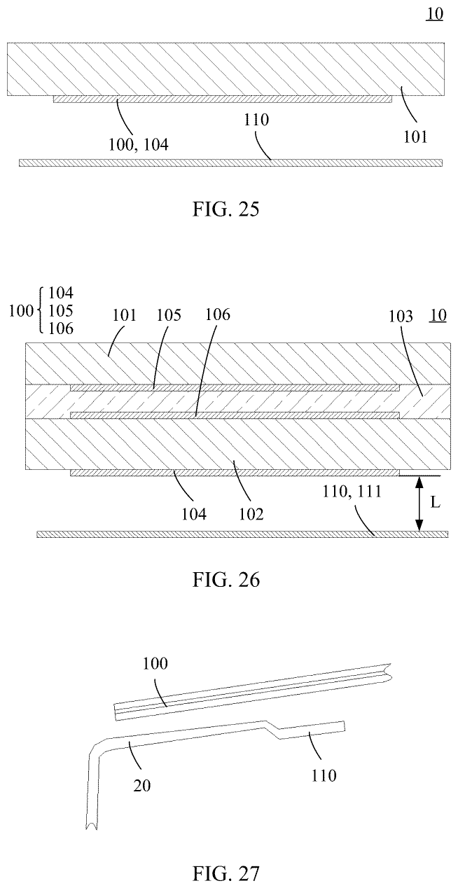

As shown in FIG. 25, in this embodiment, the antenna assembly 10 further includes a first dielectric layer 101, the antenna element 100 includes the first antenna element 104, the first antenna element 104 is disposed on the first dielectric layer 101, and the reflection element 110 and the first dielectric layer 101 are disposed at a spacing. The antenna element 100 may be fastened through the first dielectric layer 101.

As shown in FIG. 26, in some embodiments, the antenna assembly 10 further includes a second dielectric layer 102 and an intermediate dielectric layer 103. The second dielectric layer 102 and the first dielectric layer 101 are laminated, the second dielectric layer 102 is disposed to face the reflection element 110, the intermediate dielectric layer 103 is located between the first dielectric layer 101 and the second dielectric layer 102, and the first antenna element 104 is disposed on a surface that is of the second dielectric layer 102 and that is away from the first dielectric layer 101. In other words, the first antenna element 104 is located between the reflection element 110 and the second dielectric layer 102. This disposition can prevent an external object from being in contact with the first antenna element 104, to protect the first antenna element 104.

In some embodiments, the antenna element 100 further includes the second antenna element 105, and the second antenna element 105 is disposed between the intermediate dielectric layer 103 and the first dielectric layer 101. In this disposition, the second antenna element 105 and the first antenna element 104 may simultaneously receive and transmit signals, to improve strength of a signal transmitted by the antenna assembly 10, and improve communication quality.

It may be understood that the first antenna element 104 may be connected to one feed line, and the second antenna element 105 is connected to another feed line, so that the first antenna element 104 and the second antenna element 105 can be fed through corresponding feed lines. Alternatively, the first antenna element 104 is connected to a feed line, and the first antenna element 104 couples a signal to the second antenna element 105, that is, the first antenna element 104 is wirelessly connected to the second antenna element 105, to reduce a quantity of wires of the antenna assembly 10.

In this embodiment, the first antenna element 104, the second antenna element 105, and the third antenna element 106 may include a transparent conductive film (like an indium tin oxide film or a transparent silver film), a flexible printed circuit (FPC), and the like. In an implementation in which the first antenna element 104, the second antenna element 105, and the third antenna element 106 each include a transparent conductive film, the first antenna element 104, the second antenna element 105, and the third antenna element 106 that each have a specific shape may be formed in a manner of coating, etching, or the like. In an implementation in which the first antenna element 104, the second antenna element 105, and the third antenna element 106 each include a flexible printed circuit, a plane in which the flexible circuit board is located may be parallel to the intermediate dielectric layer 103. The flexible circuit board may alternatively be bent and disposed on a corresponding dielectric layer.

In another embodiment, alternatively, the first antenna element 104, the second antenna element 105, and the third antenna element 106 each may include a metal film layer. Correspondingly, processing such as etching or cutting may be performed on the metal film layer, to form the first antenna element 104, the second antenna element 105, and the third antenna element 106 that each have a specific shape.

Still as shown in FIG. 26, in the foregoing embodiment, the antenna element 100 further includes the third antenna element 106, and the third antenna element 106 is disposed between the intermediate dielectric layer 103 and the second dielectric layer 102. In this disposition, the third antenna element 106 and the first antenna element 104 may simultaneously receive and transmit signals, to improve strength of a signal transmitted by the antenna assembly 10, and improve communication quality.

It may be understood that the first antenna element 104 may be connected to one feed line, and the third antenna element 106 is connected to another feed line, so that the first antenna element 104 and the third antenna element 106 can be fed through corresponding feed lines. Alternatively, the first antenna element 104 is connected to a feed line, and the first antenna element 104 couples a signal to the third antenna element 106, that is, the first antenna element 104 is wirelessly connected to the third antenna element 106, to reduce the quantity of wires of the antenna assembly 10.

In an implementation in which the antenna assembly 10 is used in the vehicle, the vehicle may be an electric vehicle or a gasoline vehicle. This is not limited in embodiments. The vehicle includes the vehicle body 20 (as shown in FIG. 2), the cab and the passenger cabin are enclosed by the vehicle body 20, a driver is in the cab, a passenger is in the passenger cabin, and the vehicle body 20 is configured to carry the driver and the passenger.

The antenna assembly 10 may be used in different locations on the vehicle, which may be described in a plurality of scenarios in the following.

### Scenario 1

Still as shown in FIG. 26, a top of the vehicle body 20 (as shown in FIG. 2) is provided with a sunroof 201, and a plate body including the first dielectric layer 101, the second dielectric layer 102, and the intermediate dielectric layer 103 may cover the sunroof 201, to seal the sunroof 201. It may be understood that, in this case, the first dielectric layer 101, the second dielectric layer 102, and the intermediate dielectric layer 103 each need to have a specific light transmittance, so that after passing through the first dielectric layer 101, the second dielectric layer 102, and the intermediate dielectric layer 103, external light enters the cab and the passenger cabin, to improve a lighting effect of the passenger cabin.

Based on the foregoing disposition, the first antenna element 104, the second antenna element 105, and the third antenna element 106 are located on the top of the vehicle body 20. After the first antenna element 104, the second antenna element 105, and the third antenna element 106 generate a signal, the signal is directly transmitted to an upper part of the vehicle body 20, so that another structure of the vehicle body 20 can be prevented from blocking the signal, to reduce a signal loss and improve efficiency of the antenna assembly 10.

For example, the second dielectric layer 102 may be disposed close to the cab of the vehicle. This disposition can prevent the first antenna element 104 from being exposed to an external environment, and further prevent the first antenna element 104 from being damaged.

### Scenario 2

Still as shown in FIG. 26, a front end of the vehicle body 20 (as shown in FIG. 2) in a longitudinal direction (a direction Y in FIG. 2) is provided with a front shielding window 202, and a plate body including the first dielectric layer 101, the second dielectric layer 102, and the intermediate dielectric layer 103 may cover the front shielding window 202, to seal the front shielding window 202. It may be understood that, in this case, the first dielectric layer 101, the second dielectric layer 102, and the intermediate dielectric layer 103 each need to have a specific light transmittance, so that the driver can observe a road surface in front of the vehicle through the front shielding window 202, to help drive the vehicle. In this case, the first antenna element 104, the second antenna element 105, and the third antenna element 106 are located at the front end of the vehicle body 20 in the longitudinal direction, so that signal strength of the front end of the vehicle body 20 in the longitudinal direction can be improved.

### Scenario 3

Still as shown in FIG. 26, a rear end of the vehicle body 20 (as shown in FIG. 3) in a longitudinal direction is provided with a rear shielding window 203, and a plate body including the first dielectric layer 101, the second dielectric layer 102, and the intermediate dielectric layer 103 may cover the rear shielding window 203, to seal the rear shielding window 203. It may be understood that, in this case, the first dielectric layer 101, the second dielectric layer 102, and the intermediate dielectric layer 103 each need to have a specific light transmittance, and light may enter the passenger cabin through the rear shielding window 203. In this case, the first antenna element 104, the second antenna element 105, and the third antenna element 106 are located at the rear end of the vehicle body 20 in the longitudinal direction, so that signal strength of the rear end of the vehicle body 20 in the longitudinal direction can be improved.

### Scenario 4

Still as shown in FIG. 26, the vehicle body 20 (as shown in FIG. 2) is provided with a front vehicle door 204 and a rear vehicle door 205, and each of the front vehicle door 204 and the rear vehicle door 205 is provided with a vehicle window 206. Correspondingly, a plate body including the first dielectric layer 101, the second dielectric layer 102, and the intermediate dielectric layer 103 may cover the vehicle window 206, to seal the vehicle window 206. It may be understood that the first dielectric layer 101, the second dielectric layer 102, and the intermediate dielectric layer 103 each need to have a specific light transmittance, and light may enter the cab and the passenger cabin through the vehicle window 206. In this case, the first antenna element 104, the second antenna element 105, and the third antenna element 106 are located at one end of the vehicle body 20 in a horizontal direction, so that signal strength of the one end of the vehicle body 20 in the horizontal direction can be improved.

### Scenario 5

Still as shown in FIG. 26, a front vehicle door 204 and a rear vehicle door 205 are provided on the vehicle body 20 (as shown in FIG. 2), and a quarter window 207 is provided on a rear side of the rear vehicle door 205. Correspondingly, a plate body including the first dielectric layer 101, the second dielectric layer 102, and the intermediate dielectric layer 103 may cover the quarter window 207, to seal the quarter window 207. It may be understood that, in this case, the first dielectric layer 101, the second dielectric layer 102, and the intermediate dielectric layer 103 each need to have a specific light transmittance, and light may enter the cab and the passenger cabin through the quarter window 207. In this case, the first antenna element 104, the second antenna element 105, and the third antenna element 106 may transmit a signal to the outside at a location of the quarter window.

In the foregoing scenarios, both the first dielectric layer 101 and the second dielectric layer 102 may be glass layers, the intermediate dielectric layer 103 may be a connection adhesive layer, and the connection adhesive layer is bonded to the first dielectric layer 101 and the second dielectric layer 102, to implement a connection between the first dielectric layer 101 and the second dielectric layer 102. The first dielectric layer 101, the second dielectric layer 102, and the intermediate dielectric layer 103 each may be a plastic layer or the like. Materials of the first dielectric layer 101, the second dielectric layer 102, and the intermediate dielectric layer 103 are not limited in embodiments.

In the foregoing scenarios, the plate body including the first dielectric layer 101, the second dielectric layer 102, and the intermediate dielectric layer 103 may cover the front shielding window 202, the sunroof 201, and the rear shielding window 203 on the vehicle body 20 (as shown in FIG. 3). In this case, the plate body forms a canopy structure. Correspondingly, an area of the sunroof 201 can be increased, to increase an amount of light in the cab and the passenger cabin. Correspondingly, the first antenna element 104, the second antenna element 105, and the third antenna element 106 may be disposed at a location corresponding to the front shielding window 202, or the first antenna element 104, the second antenna element 105, and the third antenna element 106 may be disposed at a location corresponding to the sunroof 201, or the first antenna element 104, the second antenna element 105, and the third antenna element 106 may be disposed at a location corresponding to the rear shielding window 203. The first antenna element 104, the second antenna element 105, and the third antenna element 106 may alternatively be disposed at locations corresponding to two or three of the front shielding window 202, the sunroof 201, and the rear shielding window 203.

In an implementation in which the antenna assembly 10 is used in the ship or the aircraft, the plate body including the first dielectric layer 101, the second dielectric layer 102, and the intermediate dielectric layer 103 may cover a window of the ship or the aircraft. The plate body including the first dielectric layer 101, the second dielectric layer 102, and the intermediate dielectric layer 103 may alternatively be disposed at another location. This is not limited in embodiments.

It may be understood that, in an implementation in which the antenna assembly 10 is used in the vehicle, the reflection element 110 and the vehicle body 20 may be an integrated structure. Correspondingly, the reflection element 110 and the vehicle body 20 may be manufactured in a same factory and formed simultaneously. Alternatively, the reflection element 110 may be connected to the vehicle body 20 in a manner of welding, bolt connection, riveting, or the like. Correspondingly, the reflection element 110 and the vehicle body 20 may be manufactured in different factories, and the reflection element 110 is mounted on the vehicle body 20 after being manufactured.

In an implementation in which the antenna assembly 10 is used in an electronic device like the mobile phone or a tablet computer, a display panel is disposed in the electronic device like the mobile phone or the tablet computer, and the first dielectric layer 101, the second dielectric layer 102, and the intermediate dielectric layer 103 may be film layers in the display panel. In this way, the display panel can transmit a signal to the outside, and can also receive a signal from the outside.

In this embodiment, a structure of the first antenna element 104 may be roughly similar to the structure of the first antenna element 104 in Embodiment 1, and correspondingly, structures of the second antenna element 105 and the third antenna element 106 may be the same as or different from that of the first antenna element 104.

In this embodiment, an external device communicating with the antenna assembly 10 may be roughly similar to that in Embodiment 1, and The antenna assembly 10 may further communicate with another external device.

### Embodiment 3

This embodiment provides a vehicle, where the vehicle may include the antenna assembly 10 in Embodiment 2. It may be understood that the vehicle in this embodiment may be an electric vehicle or a gasoline vehicle. This is not limited in embodiments.

The vehicle includes the vehicle body 20 (as shown in FIG. 2), a cab and a passenger cabin are enclosed by the vehicle body 20, a driver is in the cab, a passenger is in the passenger cabin, and the vehicle body 20 is configured to carry the driver and the passenger.

As shown in FIG. 27, a top of the vehicle body 20 includes a reflection element 110. In this disposition, the reflection element 110 may reflect, to an upper part of the vehicle body 20, a signal that is generated by an antenna element 100 and that is transmitted to the cab and the passenger cabin, to improve signal strength of the upper part of the vehicle body 20, and further improve communication quality. In addition, compared with a case in which the reflection element 110 is not disposed, a case in which the reflection element 110 reflects the signal to the upper part of the vehicle body 20 can avoid a signal loss caused by signal transmission to the vehicle body 20 and the ground, and further improve efficiency of the antenna assembly 10.

In some embodiments, the reflection element 110 and the vehicle body 20 may be an integrated structure. Correspondingly, the reflection element 110 and the vehicle body 20 may be manufactured in a same factory and formed simultaneously.

In another embodiment, the reflection element 110 may alternatively be connected to the vehicle body 20 in a manner of welding, bolt connection, riveting, or the like. Correspondingly, the reflection element 110 and the vehicle body 20 may be manufactured in different factories, and the reflection element 110 is mounted on the vehicle body 20 after being manufactured.

In this embodiment, the antenna assembly 10 may be arranged on the top of the vehicle body 20 in a plurality of manners, which may be described in a plurality of scenarios in the following.

### Scenario 1

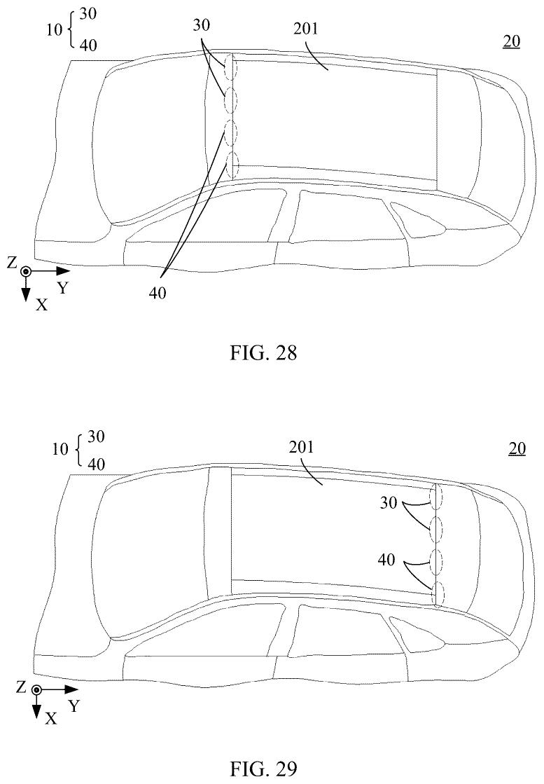

As shown in FIG. 28, the antenna assembly 10 includes a first antenna assembly 30 and a second antenna assembly 40, and both the first antenna assembly 30 and the second antenna assembly 40 are disposed at a front end of the vehicle body 20 in a longitudinal direction (a reverse direction of a direction Y). This disposition can improve signal strength of the front end of the vehicle body 20 in the longitudinal direction.

In an implementation in which the vehicle body 20 is provided with a sunroof 201, reflection elements 110 of the first antenna assembly 30 and the second antenna assembly 40 may be located in front of the sunroof 201 in the longitudinal direction of the vehicle body 20. For example, the reflection elements 110 of the first antenna assembly 30 and the second antenna assembly 40 each may be located at an edge in front of the sunroof 201, or the reflection elements 110 of the first antenna assembly and the second antenna assembly 40 each are located at another location in front of the sunroof 201.

In some implementations, there may be two first antenna assemblies 30 and two second antenna assemblies 40. In this disposition, all the first antenna assemblies 30 and second antenna assemblies 40 can form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 2

As shown in FIG. 29, the antenna assembly 10 includes a first antenna assembly 30 and a second antenna assembly 40, and both the first antenna assembly 30 and the second antenna assembly 40 are disposed at a rear end of the vehicle body 20 in a longitudinal direction (a direction Y). This disposition can improve signal strength of the rear end of the vehicle body 20 in the longitudinal direction.

In an implementation in which the vehicle body 20 is provided with a sunroof 201, reflection elements 110 of the first antenna assembly 30 and the second antenna assembly 40 may be located in rear of the sunroof 201 in the longitudinal direction of the vehicle body 20. For example, the reflection elements 110 of the first antenna assembly 30 and the second antenna assembly 40 each may be located at an edge of the sunroof 201, or the reflection elements 110 of the first antenna assembly and the second antenna assembly 40 each are located at another location in rear of the sunroof 201.

In some implementations, there may be two first antenna assemblies 30 and two second antenna assemblies 40. In this disposition, all the first antenna assemblies 30 and second antenna assemblies 40 can form a MIMO system, to improve communication quality.

A quantity of antenna assemblies 10 is not limited in embodiments, and the quantity of antenna assemblies 10 may alternatively be 5, 6, or the like.

### Scenario 3

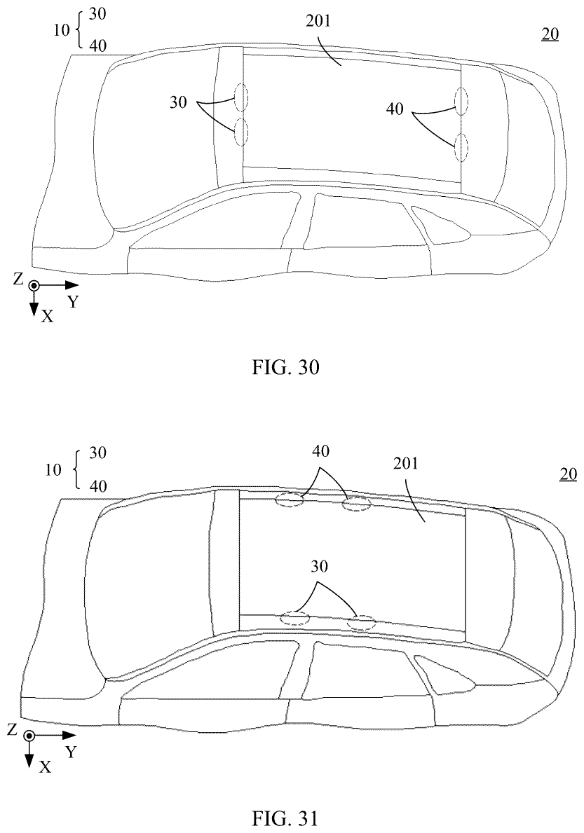

As shown in FIG. 30, the antenna assembly 10 includes a first antenna assembly 30 and a second antenna assembly 40, the first antenna assembly 30 is disposed at a front end of the vehicle body 20 in a longitudinal direction (a reverse direction of a direction Y), and the second antenna assembly 40 is disposed at a rear end of the vehicle body 20 in the longitudinal direction (the direction Y). This disposition can ensure that the front end and the rear end of the vehicle body 20 in the longitudinal direction each have specific signal strength.

In an implementation in which the vehicle body 20 is provided with a sunroof 201, a reflection element 110 of the first antenna assembly 30 may be located in front of the sunroof 201 in the longitudinal direction of the vehicle body 20, and a reflection element 110 of the second antenna assembly 40 may be located at the rear end of the sunroof 201 in the longitudinal direction. For example, the reflection elements 110 of the first antenna assembly 30 and the second antenna assembly 40 each may be located at an edge of the sunroof 201; or the reflection element 110 of the first antenna assembly is located at another location in front of the sunroof 201, and the reflection element 110 of the second antenna assembly is located at another location in rear of the sunroof 201.

In some implementations, there may be two first antenna assemblies 30 and two second antenna assemblies 40. In this disposition, all the first antenna assemblies 30 and second antenna assemblies 40 can form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 4

As shown in FIG. 31, the antenna assembly 10 includes a first antenna assembly 30 and a second antenna assembly 40, the first antenna assembly 30 is disposed at one end of the vehicle body 20 in a horizontal direction (a direction X), and the second antenna assembly 40 is disposed at the other end of the vehicle body 20 in the horizontal direction (a reverse direction of the direction X). This disposition can ensure that two ends of the vehicle body 20 in the horizontal direction each have specific signal strength.

In an implementation in which the vehicle body 20 is provided with a sunroof 201, a reflection element 110 of the first antenna assembly 30 may be located at one end of the sunroof 201 in the horizontal direction of the vehicle body 20, and a reflection element 110 of the second antenna assembly 40 may be located at the other end of the sunroof 201 in the horizontal direction. For example, the reflection elements 110 of the first antenna assembly 30 and the second antenna assembly 40 each may be located at an edge of the sunroof 201.

In some implementations, there may be two first antenna assemblies 30 and two second antenna assemblies 40. In this disposition, all the first antenna assemblies 30 and second antenna assemblies 40 can form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 5

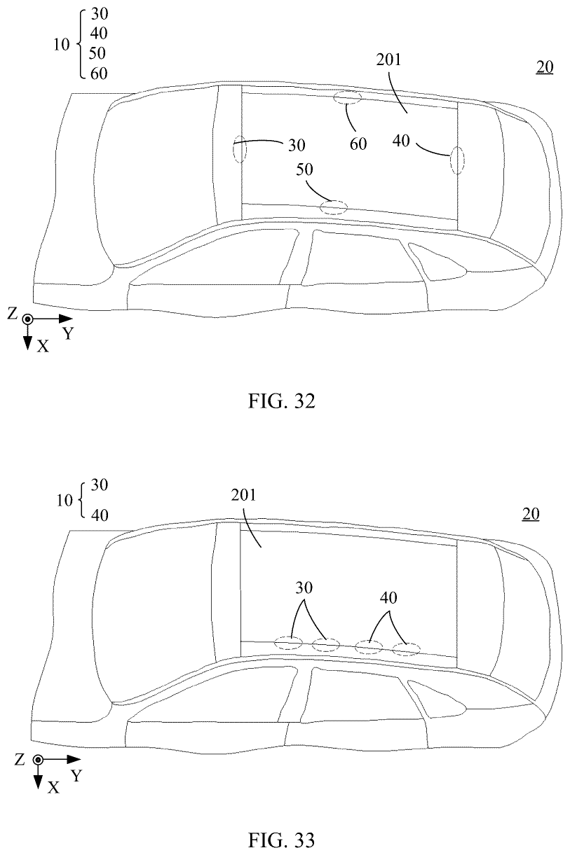

As shown in FIG. 32, the antenna assembly 10 includes a first antenna assembly 30, a second antenna assembly 40, a third antenna assembly 50, and a fourth antenna assembly 60. The first antenna assembly 30 may be located at a front end of the vehicle body 20 in a longitudinal direction (a reverse direction of a direction Y), the second antenna assembly 40 may be located at a rear end of the vehicle body 20 in the longitudinal direction (the direction Y), the third antenna may be located at one end of the vehicle body 20 in a horizontal direction (a direction X), and the fourth antenna may be located at the other end of the vehicle body 20 in the horizontal direction (a reverse direction of the direction X). In this disposition, the first antenna assembly 30, the second antenna assembly 40, the third antenna assembly 50, and the fourth antenna assembly 60 are disposed in a distributed manner, so that a signal coverage area of the antenna assembly 10 can be improved. In addition, the first antenna assembly 30, the second antenna assembly 40, the third antenna assembly 50, and the fourth antenna assembly 60 form a multi-input multi-output (MIMO) system, to improve communication quality.

In an implementation in which the vehicle body 20 is provided with a sunroof 201, reflection elements 110 of the first antenna assembly 30, the second antenna assembly 40, the third antenna assembly 50, and the fourth antenna assembly 60 each may be disposed on an edge of the sunroof 201. Certainly, each of the reflection elements 110 may alternatively be disposed at another location.

### Scenario 6

As shown in FIG. 33, the antenna assembly 10 includes a first antenna assembly 30 and a second antenna assembly 40, and both the first antenna assembly 30 and the second antenna assembly 40 are disposed at one end of the vehicle body 20 in a horizontal direction (a direction X). This disposition can improve signal strength of the one end of the vehicle body 20 in the horizontal direction. In an implementation in which the vehicle body 20 is provided with a sunroof 201, reflection elements 110 of the first antenna assembly 30 and the second antenna assembly 40 may be located on one side of the sunroof 201 in the horizontal direction of the vehicle body 20. For example, the reflection elements 110 of the first antenna assembly 30 and the second antenna assembly 40 each may be located at an edge of the sunroof 201.

In some implementations, there may be two first antenna assemblies 30 and two second antenna assemblies 40. In this disposition, all the first antenna assemblies 30 and second antenna assemblies 40 can form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 7

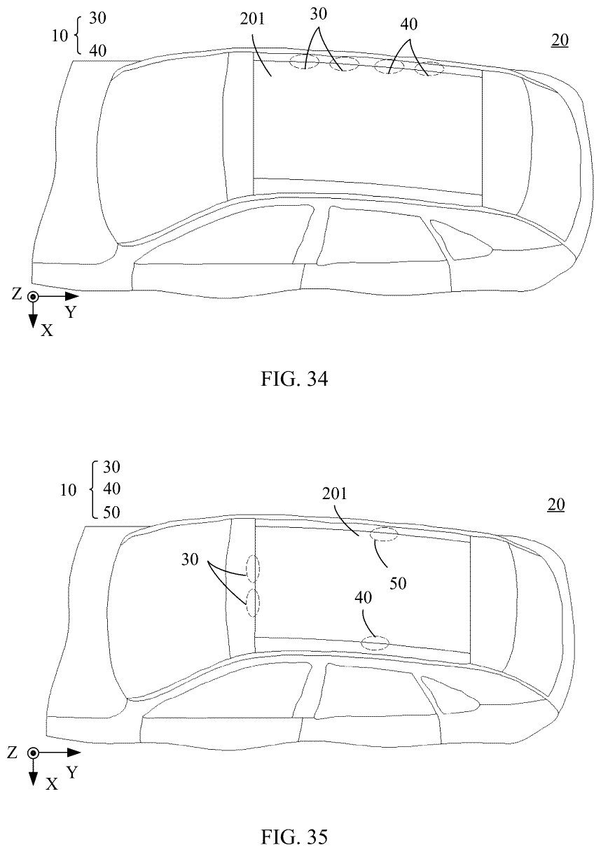

As shown in FIG. 34, the antenna assembly 10 includes a first antenna assembly 30 and a second antenna assembly 40, and both the first antenna assembly 30 and the second antenna assembly 40 are disposed at the other end of the vehicle body 20 in a horizontal direction (a reverse direction of a direction X). This disposition can improve signal strength of the other end of the vehicle body 20 in the horizontal direction.

In an implementation in which the vehicle body 20 is provided with a sunroof 201, reflection elements 110 of the first antenna assembly 30 and the second antenna assembly 40 may be located on the other side of the sunroof 201 in the horizontal direction of the vehicle body 20. For example, the reflection elements 110 of the first antenna assembly 30 and the second antenna assembly 40 each may be located at an edge of the sunroof 201.

In some implementations, there may be two first antenna assemblies 30 and two second antenna assemblies 40. In this disposition, all the first antenna assemblies 30 and second antenna assemblies 40 can form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 8

As shown in FIG. 35, the antenna assembly 10 includes a first antenna assembly 30, a second antenna assembly 40, and a third antenna assembly 50. The first antenna assembly 30 is disposed at a front end of the vehicle body 20 in a longitudinal direction (a reverse direction of a direction Y), the second antenna assembly 40 is disposed at one end of the vehicle body 20 in a horizontal direction (a direction X), and the third antenna assembly 50 is disposed at the other end of the vehicle body 20 in the horizontal direction (a reverse direction of the direction X). This disposition can ensure that there is high signal strength above a first half part of the vehicle body 20.

In an implementation in which the vehicle body 20 is provided with a sunroof 201, reflection elements 110 of the first antenna assembly 30, the second antenna assembly 40, and the third antenna assembly 50 each may be disposed on an edge of the sunroof 201.

For example, there are two first antenna assemblies 30, or two second antenna assemblies 40, or two third antenna assemblies 50, to form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 9

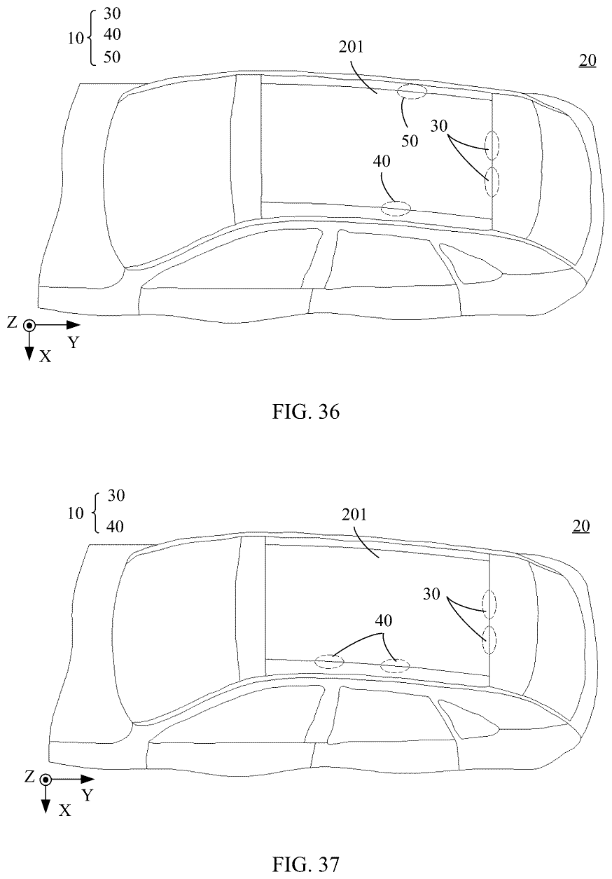

As shown in FIG. 36, the antenna assembly 10 includes a first antenna assembly 30, a second antenna assembly 40, and a third antenna assembly 50. The first antenna assembly 30 is disposed at a rear end of the vehicle body 20 in a longitudinal direction (a direction Y), the second antenna assembly 40 is disposed at one end of the vehicle body 20 in a horizontal direction (a direction X), and the third antenna assembly 50 is disposed at the other end of the vehicle body 20 in the horizontal direction (a reverse direction of the direction X). This disposition can ensure that there is high signal strength above a second half part of the vehicle body 20.

In an implementation in which the vehicle body 20 is provided with a sunroof 201, reflection elements 110 of the first antenna assembly 30, the second antenna assembly 40, and the third antenna assembly 50 each may be disposed on an edge of the sunroof 201.

For example, there are two first antenna assemblies 30, or two second antenna assemblies 40, or two third antenna assemblies 50, to form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 10

As shown in FIG. 37, the antenna assembly 10 includes a first antenna assembly 30 and a second antenna assembly 40, the first antenna assembly 30 is disposed at a rear end of the vehicle body 20 in a longitudinal direction (a direction Y), and the second antenna assembly 40 is disposed at one end of the vehicle body 20 in a horizontal direction (a direction X). This disposition can ensure signal strength above a lower right part of the vehicle body 20.

In an implementation in which the vehicle body 20 is provided with a sunroof 201, reflection elements 110 of the first antenna assembly 30 and the second antenna assembly 40 each may be disposed on an edge of the sunroof 201.

For example, there may be two first antenna assemblies 30 and two second antenna assemblies 40, to form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 11

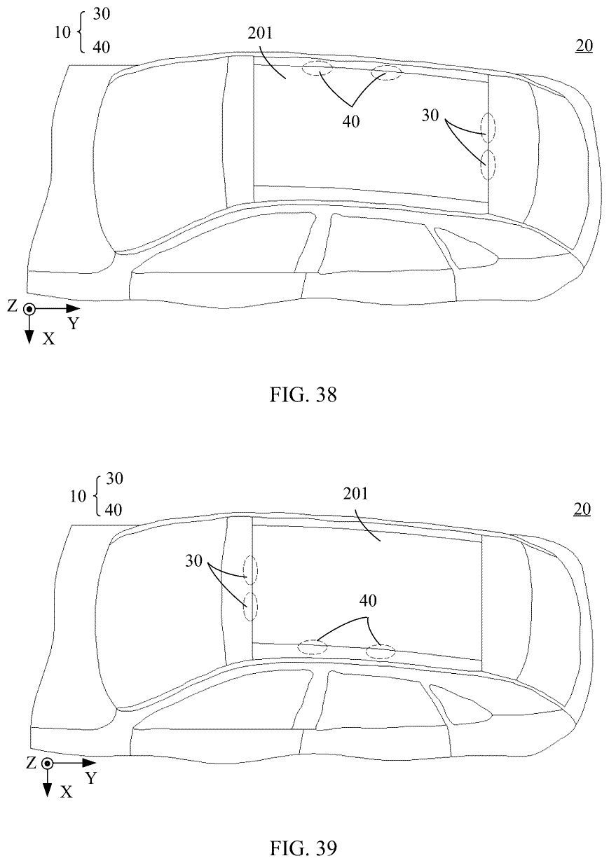

As shown in FIG. 38, the antenna assembly 10 includes a first antenna assembly 30 and a second antenna assembly 40, the first antenna assembly 30 is disposed at a rear end of the vehicle body 20 in a longitudinal direction (a direction Y), and the second antenna assembly 40 is disposed at the other end of the vehicle body 20 in a horizontal direction (a reverse direction of a direction X). This disposition can ensure signal strength above an upper right part of the vehicle body 20.

In an implementation in which the vehicle body 20 is provided with a sunroof 201, reflection elements 110 of the first antenna assembly 30 and the second antenna assembly 40 each may be disposed on an edge of the sunroof 201.

For example, there may be two first antenna assemblies 30 and two second antenna assemblies 40, to form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 12

As shown in FIG. 39, the antenna assembly 10 includes a first antenna assembly 30 and a second antenna assembly 40, the first antenna assembly 30 is disposed at a front end of the vehicle body 20 in a longitudinal direction (a reverse direction of a direction Y), and the second antenna assembly 40 is disposed at one end of the vehicle body 20 in a horizontal direction (a direction X). This disposition can ensure signal strength above an upper left part of the vehicle body 20.

In an implementation in which the vehicle body 20 is provided with a sunroof 201, reflection elements 110 of the first antenna assembly 30 and the second antenna assembly 40 each may be disposed on an edge of the sunroof 201.

For example, there may be two first antenna assemblies 30 and two second antenna assemblies 40, to form a multi-input multi-output (MIMO) system, to improve communication quality.

A quantity of antenna assemblies 10 is not limited in embodiments, and the quantity of antenna assemblies 10 may alternatively be 5, 6, or the like.

### Scenario 13

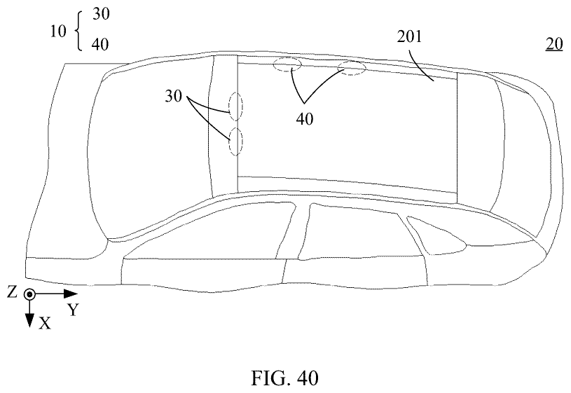

As shown in FIG. 40, the antenna assembly 10 includes a first antenna assembly 30 and a second antenna assembly 40, the first antenna assembly 30 is disposed at a front end of the vehicle body 20 in a longitudinal direction (a reverse direction of a direction Y), and the second antenna assembly 40 is disposed at the other end of the vehicle body 20 in a horizontal direction (a reverse direction of a direction X). This disposition can ensure signal strength above a lower left part of the vehicle body 20.

In an implementation in which the vehicle body 20 is provided with a sunroof 201, reflection elements 110 of the first antenna assembly 30 and the second antenna assembly 40 each may be disposed on an edge of the sunroof 201.

For example, there may be two first antenna assemblies 30 and two second antenna assemblies 40, to form a multi-input multi-output (MIMO) system, to improve communication quality.

A quantity of antenna assemblies 10 is not limited in embodiments, and the quantity of antenna assemblies 10 may alternatively be 5, 6, or the like.

In the foregoing scenarios, first dielectric layers 101 of all antenna assemblies 10 are an integrated structure, second dielectric layers 102 of all antenna assemblies 10 are an integrated structure, and third dielectric layers of all antenna assemblies 10 are an integrated structure. In this way, the first dielectric layers 101, the second dielectric layers 102, and the third dielectric layers of all antennas can form a whole plate body, and the plate body may cover the sunroof 201, to seal the sunroof 201.

In some implementations, the plate body may cover a front shielding window 202, the sunroof 201, and a rear shielding window 203 on the vehicle body 20. In this case, the plate body forms a canopy structure, so that an area of the sunroof 201 can be increased, to increase an amount of light in the cab and the passenger cabin. Correspondingly, the antenna element 100 in each antenna assembly 10 may be disposed at a location corresponding to the front shielding window 202, or the antenna element 100 in each antenna assembly 10 is disposed at a location corresponding to the sunroof 201, or the antenna element 100 in each antenna assembly 10 is disposed at a location corresponding to the rear shielding window 203. The antenna element 100 in each antenna assembly 10 may alternatively be disposed at corresponding locations of two or three of the front shielding window 202, the sunroof 201, and the rear shielding window 203.

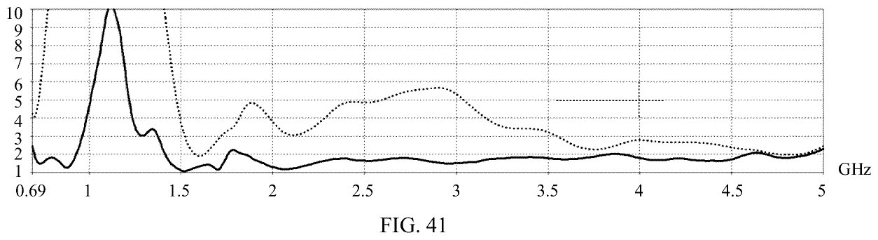

As shown in FIG. 41, a dashed line is a curve of a standing wave ratio and a frequency when the reflection element 110 is not disposed in the antenna assembly 10, and a solid line is a curve of a standing wave ratio and a frequency when the reflection element 110 is disposed in the antenna assembly 10. It can be learned by comparing the two curves that, when the antenna assembly 10 is in a frequency range of 0.69 GHz to 4.5 GHz, the standing wave ratio existing when the reflection element 110 is disposed in the antenna assembly 10 is closer to 2 than the standing wave ratio existing when the reflection element 110 is not disposed in the antenna assembly 10.

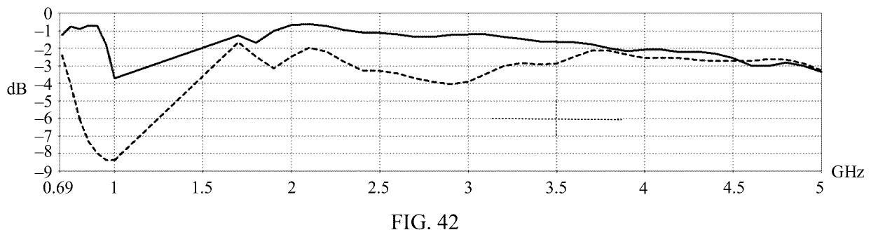

As shown in FIG. 42, a dashed line is a curve of efficiency and a frequency when the reflection element 110 is not disposed in the antenna assembly 10, and a solid line is a curve of efficiency and a frequency when the reflection element 110 is disposed in the antenna assembly 10. It can be learned by comparing the two curves that, when the antenna assembly 10 is in a frequency range of 0.69 GHz to 4.5 GHz, efficiency of the antenna assembly 10 in which the reflection element 110 is disposed is higher than efficiency of the antenna assembly 10 in which no reflection element is disposed.

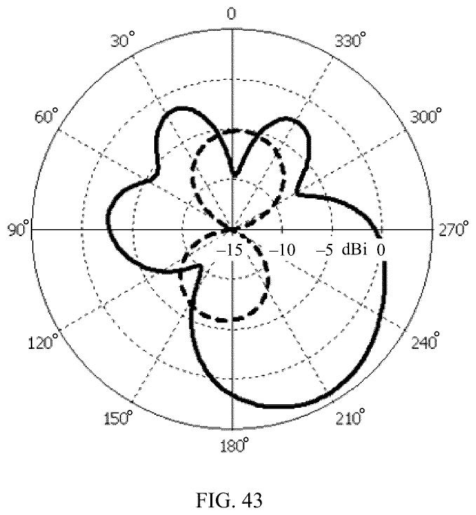

As shown in FIG. 43, a dashed line is a directivity diagram when the reflection element 110 is not disposed in the antenna assembly 10, and a solid line is a directivity diagram when the reflection element 110 is disposed in the antenna assembly 10. It can be learned by comparing the two that a power gain of the antenna assembly 10 in which the reflection element 110 is disposed is higher than a power gain of the antenna assembly 10 in which no reflection element is disposed.

### Embodiment 4

This embodiment provides a signal transmitting apparatus, including the antenna assembly 10 in Embodiment 1 or Embodiment 2. The signal transmitting apparatus may be used in a device like a vehicle, an airplane, a ship, or a mobile phone, to implement communication with an external device through the signal transmitting apparatus. An application scenario of the signal transmitting apparatus is not limited in embodiments.

In an implementation in which the signal transmitting apparatus is used in the vehicle, the vehicle includes a body 20 enclosing a cab and a passenger cabin. A reflection element 110 of the antenna assembly 10 and the vehicle body 20 may be an integrated structure. Correspondingly, the reflection element 110 and the vehicle body 20 may be manufactured in a same factory and formed simultaneously. Alternatively, the reflection element 110 may be connected to the vehicle body 20 in a manner of welding, bolt connection, riveting, or the like. Correspondingly, the reflection element 110 and the vehicle body 20 may be manufactured in different factories, and the reflection element 110 is mounted on the vehicle body 20 after being manufactured.

In this embodiment, a structure, a disposition location, and a connection manner of the antenna assembly 10 may be roughly the same as those in Embodiment 1 or Embodiment 2, and details are not described herein again.

The foregoing descriptions are merely example implementations of embodiments of this disclosure, but are not intended to limit the protection scope of this disclosure. Any variation or replacement readily figured out by a person skilled in the art within the technical scope disclosed in this application shall fall within the protection scope of this disclosure. Therefore, the protection scope of this disclosure shall be subject to the protection scope of the claims.

1. An antenna assembly, comprising:
a first dielectric layer that is laminated;
a second dielectric layer that is laminated and comprising a surface that is distal from the first dielectric layer;
an intermediate dielectric layer disposed between the first dielectric layer and the second dielectric layer;
a first antenna element disposed on the surface;
a second antenna element disposed between the intermediate dielectric layer and the first dielectric layer; and
a third antenna element disposed between the intermediate dielectric layer and the second dielectric layer.

2. The antenna assembly of claim 1, further comprising a reflection element disposed on a side that is of the second dielectric layer that is distal from the first dielectric layer, wherein the reflection element is configured to reflect signals transmitted by the first antenna element, the second antenna element, and the third antenna element toward the reflection element.

3. The antenna assembly of claim 2, wherein the reflection element lies in a plane parallel with the first antenna element, the second antenna element, and the third antenna element, and wherein an area of the reflection element is greater than or equal to areas of the first antenna element, the second antenna element, and the third antenna element.

4. The antenna assembly of claim 2, wherein the reflection element lies in a plane parallel with the first antenna element, the second antenna element, and the third antenna element, and wherein an area of the reflection element is less than areas of the first antenna element, the second antenna element, and the third antenna element.

5. (canceled)

6. The antenna assembly of claim 2, wherein a first distance between the reflection element and the first antenna element is 0.05 to 1 times a wavelength of the signals transmitted by the first antenna element, the second antenna element, and the third antenna element.

7. The antenna assembly of claim 2, further comprising a third dielectric layer is disposed between the first antenna element and the reflection element.

8. The antenna assembly of claim 2, wherein the reflection element comprises a reflection plate.

9. The antenna assembly of claim 2, further comprising a guide structure disposed on the reflection element, wherein the guide structure is configured to reflect a signal towards a first direction.

10. The antenna assembly of claim 9, wherein the guide structure comprises a guide protrusion provided on the reflection element.

11. The antenna assembly of claim 9, wherein the guide structure comprises a first guide structure protrusion and a second guide structure protrusion, and wherein the first guide structure and the second guide structure are disposed on the reflection element.

12. The antenna assembly of claim 9, wherein the guide structure and the reflection element are an integrated structure.

13. The antenna assembly of claim 9, wherein the guide structure is connected to the reflection element.

14. The antenna assembly of claim 2, wherein the reflection element further comprises a through hole.

15. The antenna assembly of claim 1, wherein the antenna assembly further comprises a feed line is electrically connected to the first antenna element.

16. The antenna assembly of claim 1, wherein the first antenna element is configured to couple a signal to the second antenna element and the third antenna element.

17. An antenna assembly, comprising:
an antenna element lying in a first plane, having a first area, and configured to transmit a signal; and
a reflection element spaced part from the antenna element, lying in a second plane that is parallel to the first plane, having a second area that is greater than or equal to the first are and configured to reflect the signal.

18.-19. (canceled)

20. A vehicle comprising:
an antenna assembly comprising:
an antenna element lying in a first plane, having a first area, and configured to transmit a signal; and
a reflection element, spaced part from the antenna element, lying in a second plane that is parallel to the first plane, having a second area that is greater than or equal to the first are and configured to reflect the signal.

21. The antenna assembly of claim 9, wherein the guide structure comprises a guide grove provided on the reflection element.

22. The antenna assembly of claim 17, wherein a first distance between the reflection element and the antenna element is 0.05 to 1 times a wavelength of the signal.

23. The antenna assembly of claim 17, wherein the antenna assembly further comprises a dielectric layer disposed between the antenna element and the reflection element.
